(19) United States
(12) Patent Application Publication
(10) Pub. No.: US 2026/0343569 A1
(43) Pub. Date: Oct. 29, 2026

(54) TECHNIQUES FOR SCHEDULING NON-CAUSAL SIDELINK TRANSMISSIONS

(71) Applicant: QUALCOMM Incorporated, San Diego, CA (US)

(72) Inventors: Luanxia YANG, Beijing (CN); Changlong XU, Beijing (CN); Shaozhen GUO, Beijing (CN); Jing SUN, San Diego, CA (US); Chih-Hao LIU, San Diego, CA (US); Xiaoxia ZHANG, San Diego, CA (US); Giovanni CHISCI, San Diego, CA (US); Siyi CHEN, Beijing (CN); Hao XU, Beijing (CN)

(21) Appl. No.: 19/122,202

(22) PCT Filed: Dec. 1, 2022
(86) PCT No.: PCT/CN2022/135803

§ 371 Date: Apr. 17, 2025

(51) Int. Cl. H04W 72/25; H04W 74/0808

(52) U.S. Cl. CPC H04W 72/25; H04W 74/0808

(57) ABSTRACT

Methods, systems, and devices for wireless communication are described. A first device may perform a channel access procedure during a first slot to reserve sidelink resources in a shared radio frequency (RF) spectrum band for a channel occupancy time (COT). The first device may transmit a non-causal sidelink transmission via the sidelink resources during a remaining portion of the first slot based on a result of the channel access procedure, where the remaining portion of the first slot begins at least one symbol after a slot boundary associated with the first slot. The first device may transmit sidelink control information (SCI) via the sidelink resources during a second slot that begins after the first slot. The SCI may indicate one or more parameters associated with the non-causal sidelink transmission, thereby enabling a second device to decode the non-causal sidelink transmission from the first slot.

### CROSS REFERENCE

The present Application is a 371 national phase filing of International PCT Application No. PCT/CN2022/135803 by YANG et al., entitled “TECHNIQUES FOR SCHEDULING NON-CAUSAL SIDELINK TRANSMISSIONS,” filed Dec. 1, 2022, which is assigned to the assignee hereof, and which is expressly incorporated by reference in its entirety herein.

### FIELD OF TECHNOLOGY

The following relates to wireless communication, including techniques for scheduling non-causal sidelink transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support contention-based channel access in a shared radio frequency (RF) spectrum band. In some cases, however, a device associated with a first radio access technology (RAT) may block or otherwise prevent a device associated with a second RAT from using resources in the shared RF spectrum band.

### SUMMARY

The described techniques relate to improved methods, systems, devices, and apparatuses that support techniques for scheduling non-causal sidelink transmissions. In accordance with aspects of the present disclosure, a first device may perform a channel access procedure during a first slot to reserve sidelink resources in a shared radio frequency (RF) spectrum band for a channel occupancy time (COT). The first device may transmit a non-causal sidelink transmission via the sidelink resources during a remaining portion of the first slot based on a result of the channel access procedure, where the remaining portion of the first slot begins at least one symbol after a slot boundary associated with the first slot. The first device may transmit sidelink control information (SCI) via the sidelink resources during a second slot that begins after the first slot. The SCI may indicate one or more parameters associated with the non-causal sidelink transmission, thereby enabling a second device to decode the non-causal sidelink transmission from the first slot.

A method for wireless communication at a first device is described. The method may include performing a channel access procedure during a first slot to reserve sidelink resources in a shared RF spectrum band for a COT. The method may further include transmitting a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The method may further include transmitting SCI via the sidelink resources in the shared RF spectrum band during a second slot that begins after the first slot, where the SCI indicates one or more parameters associated with the non-causal sidelink transmission in the first slot.

An apparatus for wireless communication at a first device is described. The apparatus may include a processor, memory coupled with the processor, and instructions stored in the memory. The instructions may be executable by the processor to cause the apparatus to perform a channel access procedure during a first slot to reserve sidelink resources in a shared RF spectrum band for a COT. The instructions may be further executable by the processor to cause the apparatus to transmit a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The instructions may be further executable by the processor to cause the apparatus to transmit SCI via the sidelink resources in the shared RF spectrum band during a second slot that begins after the first slot, where the SCI indicates one or more parameters associated with the non-causal sidelink transmission in the first slot.

Another apparatus for wireless communication at a first device is described. The apparatus may include means for performing a channel access procedure during a first slot to reserve sidelink resources in a shared RF spectrum band for a COT. The apparatus may further include means for transmitting a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The apparatus may further include means for transmitting SCI via the sidelink resources in the shared RF spectrum band during a second slot that begins after the first slot, where the SCI indicates one or more parameters associated with the non-causal sidelink transmission in the first slot.

A non-transitory computer-readable medium storing code for wireless communication at a first device is described. The code may include instructions executable by a processor to perform a channel access procedure during a first slot to reserve sidelink resources in a shared RF spectrum band for a COT. The instructions may be further executable by the processor to transmit a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The instructions may be further executable by the processor to transmit SCI via the sidelink resources in the shared RF spectrum band during a second slot that begins after the first slot, where the SCI indicates one or more parameters associated with the non-causal sidelink transmission in the first slot.

Some examples of the methods, apparatuses, and non-transitory computer-readable media described herein may further include operations, features, means, or instructions for transmitting at least one sidelink transmission during the second slot using the one or more parameters associated with the non-causal sidelink transmission in the first slot, the non-causal sidelink transmission including a first instance of a transport block (TB), the at least one sidelink transmission including a second instance of the TB.

In some examples of the methods, apparatuses, and non-transitory computer-readable media described herein, transmitting the SCI during the second slot may include operations, features, means, or instructions for transmitting first-stage SCI (also denoted as SCI-1) or second-stage SCI (also denoted as SCI-2) that indicates whether a sidelink transmission starting at a non-default symbol is present in the first slot.

In some examples of the methods, apparatuses, and non-transitory computer-readable media described herein, transmitting the SCI during the second slot may include operations, features, means, or instructions for transmitting first-stage SCI or second-stage SCI that indicates an absolute value of a first symbol of the non-causal sidelink transmission in the first slot.

In some examples of the methods, apparatuses, and non-transitory computer-readable media described herein, transmitting the non-causal sidelink transmission may include operations, features, means, or instructions for transmitting the non-causal sidelink transmission during the remaining portion of the first slot based on completing the channel access procedure prior to a seventh symbol in the first slot in accordance with a capability of the first device to perform non-causal sidelink transmissions.

In some examples of the methods, apparatuses, and non-transitory computer-readable media described herein, transmitting the SCI during the second slot may include operations, features, means, or instructions for transmitting first-stage SCI or second-stage SCI that indicates a quantized position of a first symbol of the non-causal sidelink transmission in the first slot.

Some examples of the methods, apparatuses, and non-transitory computer-readable media described herein may further include operations, features, means, or instructions for transmitting at least one sidelink transmission during the second slot using the one or more parameters associated with the non-causal sidelink transmission in the first slot, the non-causal sidelink transmission including a first TB, the at least one sidelink transmission including a second TB that is different from the first TB.

In some examples of the methods, apparatuses, and non-transitory computer-readable media described herein, transmitting the SCI during the second slot may include operations, features, means, or instructions for transmitting first-stage SCI or second-stage SCI that indicates whether non-causal rate matching is used for sidelink transmissions in the first slot.

In some examples of the methods, apparatuses, and non-transitory computer-readable media described herein, the first TB and the second TB may be associated with a same destination identifier.

In some examples of the methods, apparatuses, and non-transitory computer-readable media described herein, transmitting the SCI during the second slot may include operations, features, means, or instructions for transmitting second-stage SCI that indicates one or more of a new data indicator (NDI), a redundancy version (RV), or a hybrid automatic repeat request (HARQ) process identifier for the first TB.

Some examples of the methods, apparatuses, and non-transitory computer-readable media described herein may further include operations, features, means, or instructions for determining a first HARQ process identifier for the first TB based on a mapping between the first slot and the second slot, where a value of the first HARQ process identifier is one less than a value of a second HARQ process identifier for the second TB.

In some examples of the methods, apparatuses, and non-transitory computer-readable media described herein, the first HARQ process identifier and the second HARQ process identifier may be indicated separately.

In some examples of the methods, apparatuses, and non-transitory computer-readable media described herein, the first TB and the second TB may be associated with different destination identifiers.

In some examples of the methods, apparatuses, and non-transitory computer-readable media described herein, transmitting the SCI during the second slot may include operations, features, means, or instructions for transmitting first SCI that indicates one or more of a HARQ process identifier, an NDI, an RV, or a destination identifier for the first TB, and transmitting second SCI that indicates one or more of a HARQ process identifier, an NDI, an RV, or a destination identifier for the second TB, where the first SCI and the second SCI are indicated separately.

In some examples of the methods, apparatuses, and non-transitory computer-readable media described herein, the SCI includes second-stage SCI and a format of the second-stage SCI indicates that non-causal rate matching is used for sidelink transmissions in the first slot.

In some examples of the methods, apparatuses, and non-transitory computer-readable media described herein, transmitting the SCI may include operations, features, means, or instructions for transmitting second-stage SCI during the first slot and retransmitting the second-stage SCI during a gap symbol between the first slot and the second slot using some or all resource elements (REs) available during the gap symbol.

Some examples of the methods, apparatuses, and non-transitory computer-readable media described herein may further include operations, features, means, or instructions for transmitting at least one sidelink transmission during the second slot via the sidelink resources using parameters that are different from the one or more parameters associated with the non-causal sidelink transmission in the first slot, the non-causal sidelink transmission including a first instance of a TB, the at least one sidelink transmission including a second instance of the TB.

In some examples of the methods, apparatuses, and non-transitory computer-readable media described herein, the first instance of the TB and the second instance of the TB may be associated with a same frequency allocation and the SCI indicates a demodulation reference signal (DMRS) pattern, a modulation and coding scheme (MCS), and a beta offset identifier for the first instance of the TB.

In some examples of the methods, apparatuses, and non-transitory computer-readable media described herein, the first instance of the TB and the second instance of the TB may be associated with different frequency allocations and the SCI indicates a DMRS pattern, an MCS, a beta offset indicator, a quantity of sub-channels, and a starting frequency for the first instance of the TB.

Some examples of the methods, apparatuses, and non-transitory computer-readable media described herein may further include operations, features, means, or instructions for transmitting at least one sidelink transmission during the second slot using parameters that are different from the one or more parameters associated with the non-causal sidelink transmission in the first slot, the non-causal sidelink transmission including a first TB, the at least one sidelink transmission including a second TB that is different from the first TB.

In some examples of the methods, apparatuses, and non-transitory computer-readable media described herein, transmitting the SCI during the second slot may include operations, features, means, or instructions for transmitting first-stage SCI or second-stage SCI that indicates a destination identifier, a HARQ process identifier, an RV, and an NDI for the first TB.

Some examples of the methods, apparatuses, and non-transitory computer-readable media described herein may further include operations, features, means, or instructions for transmitting at least one sidelink transmission during the second slot using the sidelink resources in the shared RF spectrum band, the non-causal sidelink transmission in the first slot including a first instance of a TB, the at least one sidelink transmission in the second slot including a second instance of the TB, and retransmitting the TB using a set of sidelink resources reserved by the SCI.

Some examples of the methods, apparatuses, and non-transitory computer-readable media described herein may further include operations, features, means, or instructions for transmitting at least one sidelink transmission during the second slot using the sidelink resources in the shared RF spectrum band, the non-causal sidelink transmission in the first slot including a first TB, the at least one sidelink transmission in the second slot including a second TB that is different from the first TB.

Some examples of the methods, apparatuses, and non-transitory computer-readable media described herein may further include operations, features, means, or instructions for retransmitting the first TB using a first set of sidelink resources reserved by the SCI and retransmitting the second TB using a second set of sidelink resources reserved by the SCI, where the first set of sidelink resources and the second set of sidelink resources each include one slot.

Some examples of the methods, apparatuses, and non-transitory computer-readable media described herein may further include operations, features, means, or instructions for transmitting at least one sidelink transmission during the second slot using the sidelink resources in the shared RF spectrum band, the non-causal sidelink transmission in the first slot including a first TB, the at least one sidelink transmission in the second slot including a second TB that is different from the first TB.

Some examples of the methods, apparatuses, and non-transitory computer-readable media described herein may further include operations, features, means, or instructions for retransmitting the first TB using a first set of sidelink resources reserved by the SCI and retransmitting the second TB using a second set of sidelink resources reserved by the SCI, where the first set of sidelink resources and the second set of sidelink resources each include two consecutive slots.

In some examples of the methods, apparatuses, and non-transitory computer-readable media described herein, transmitting the SCI during the second slot may include operations, features, means, or instructions for transmitting first-stage SCI or second-stage SCI that indicates the first set of sidelink resources reserved for retransmission of the first TB.

In some examples of the methods, apparatuses, and non-transitory computer-readable media described herein, the sidelink resources in the shared RF spectrum band include sidelink shared channel resources, sidelink control channel resources, DMRS resources, or a combination thereof, and the COT includes at least the remaining portion of the first slot and the second slot that begins after the first slot.

In some examples of the methods, apparatuses, and non-transitory computer-readable media described herein, the one or more parameters indicated by the SCI include one or more of a DMRS pattern, an MCS, a beta offset indicator, a frequency allocation, a HARQ process identifier, a destination identifier, an NDI, an RV, a starting frequency, or a quantity of sub-channels associated with the non-causal sidelink transmission in the first slot.

A method for wireless communication at a second device is described. The method may include monitoring sidelink resources in a shared RF spectrum band. The method may further include receiving, from a first device that has reserved the sidelink resources in the shared RF spectrum band for a COT, SCI that indicates one or more parameters associated with a non-causal sidelink transmission in a first slot, where the SCI is received during a second slot that begins after the first slot. The method may further include decoding the non-causal sidelink transmission from the first slot based on the one or more parameters indicated by the SCI, where the non-causal sidelink transmission begins at least one symbol after a slot boundary associated with the first slot.

An apparatus for wireless communication at a second device is described. The apparatus may include a processor, memory coupled with the processor, and instructions stored in the memory. The instructions may be executable by the processor to cause the apparatus to monitor sidelink resources in a shared RF spectrum band. The instructions may be further executable by the processor to cause the apparatus to receive, from a first device that has reserved the sidelink resources in the shared RF spectrum band for a COT, SCI that indicates one or more parameters associated with a non-causal sidelink transmission in a first slot, where the SCI is received during a second slot that begins after the first slot. The instructions may be further executable by the processor to cause the apparatus to decode the non-causal sidelink transmission from the first slot based on the one or more parameters indicated by the SCI, where the non-causal sidelink transmission begins at least one symbol after a slot boundary associated with the first slot.

Another apparatus for wireless communication at a second device is described. The apparatus may include means for monitoring sidelink resources in a shared RF spectrum band. The apparatus may further include means for receiving, from a first device that has reserved the sidelink resources in the shared RF spectrum band for a COT, SCI that indicates one or more parameters associated with a non-causal sidelink transmission in a first slot, where the SCI is received during a second slot that begins after the first slot. The apparatus may further include means for decoding the non-causal sidelink transmission from the first slot based on the one or more parameters indicated by the SCI, where the non-causal sidelink transmission begins at least one symbol after a slot boundary associated with the first slot.

A non-transitory computer-readable medium storing code for wireless communication at a second device is described. The code may include instructions executable by a processor to monitor sidelink resources in a shared RF spectrum band. The instructions may be further executable by the processor to receive, from a first device that has reserved the sidelink resources in the shared RF spectrum band for a COT, SCI that indicates one or more parameters associated with a non-causal sidelink transmission in a first slot, where the SCI is received during a second slot that begins after the first slot. The instructions may be further executable by the processor to decode the non-causal sidelink transmission from the first slot based on the one or more parameters indicated by the SCI, where the non-causal sidelink transmission begins at least one symbol after a slot boundary associated with the first slot.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, and the like). While some examples may or may not be specifically directed to use cases or applications, a wide assortment of applicability of described innovations may occur.

Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, and the like). It is intended that innovations described herein may be practiced in a wide variety of devices, chip-level components, systems, distributed arrangements, and end-user devices of varying sizes, shapes, and constitutions.

### BRIEF DESCRIPTION OF THE DRAWINGS

FIG. 1 illustrates an example of a wireless communications system that supports techniques for scheduling non-causal sidelink transmissions in accordance with one or more aspects of the present disclosure.

FIG. 2 illustrates an example of a network architecture that supports techniques for scheduling non-causal sidelink transmissions in accordance with one or more aspects of the present disclosure.

FIG. 3 illustrates an example of a wireless communications system that supports techniques for scheduling non-causal sidelink transmissions in accordance with one or more aspects of the present disclosure.

FIGS. 4 through 6 illustrate examples of resource diagrams that support techniques for scheduling non-causal sidelink transmissions in accordance with one or more aspects of the present disclosure.

FIG. 7 illustrates an example of a process flow that supports techniques for scheduling non-causal sidelink transmissions in accordance with one or more aspects of the present disclosure.

FIGS. 8 and 9 illustrate block diagrams of devices that support techniques for scheduling non-causal sidelink transmissions in accordance with one or more aspects of the present disclosure.

FIG. 10 illustrates a block diagram of a communications manager that supports techniques for scheduling non-causal sidelink transmissions in accordance with one or more aspects of the present disclosure.

FIG. 11 illustrates a diagram of a system including a device that supports techniques for scheduling non-causal sidelink transmissions in accordance with one or more aspects of the present disclosure.

FIGS. 12 through 14 illustrate flowcharts showing methods that support techniques for scheduling non-causal sidelink transmissions in accordance with one or more aspects of the present disclosure.

### DETAILED DESCRIPTION

A wireless communications system may include a number of devices (such as a user equipment (UE) or a network entity) that are capable of transmitting and receiving radio frequency (RF) signals according to Long Term Evolution (LTE), 3G, 4G or 5G (New Radio (NR)) standards promulgated by the third Generation Partnership Project (3GPP), among others. Some wireless communications systems may support contention-based channel access in a shared RF spectrum band, such as a sidelink unlicensed (SL-U) frequency band. In a contention-based channel access scheme, a transmitting device may perform a listen-before-talk (LBT) procedure to ensure that a wireless medium is available before using the wireless medium.

In some cases, however, if the transmitting device (also referred to herein as a first device) clears the LBT procedure in the middle of a slot, the transmitting device may have to wait until the start of the next slot to begin transmission(s). Thus, if another device (such as a Wi-Fi device) occupies the wireless medium between the time at which the transmitting device clears the LBT procedure and the start of the next slot, the transmitting device may be unable to use the wireless medium during the next slot. As such, current slot-based channel access schemes may lead to inter-radio access technology (RAT) issues, latency, interference, etc. In some cases, using mini-slots and/or slot offsets may increase the number of possible transmission starting points available to transmitting devices. However, such techniques may be associated with higher complexity and increased processing overhead, and may require receiving devices to monitor a larger number of decoding hypotheses.

In accordance with the techniques described herein, a transmitting device may use non-causal physical sidelink shared channel (PSSCH) rate matching to occupy the wireless medium at a non-default starting point (for example, in the middle of a slot rather than at the beginning slot, or immediately after an AGC of the slot, or immediately after a control channel of the slot, or after an earliest in time symbol period of a slot of a sidelink channel allocated for PSSCH) without increasing the processing/decoding burden on the receiving device (also referred to herein as a second device). For example, if the transmitting device clears the LBT procedure during the sixth symbol of a slot, the transmitting device may begin a PSSCH transmission in the seventh symbol of the slot (as opposed to the first symbol of the following slot), thereby decreasing the probability of other devices occupying the wireless medium before the transmitting device.

To complete the PSSCH transmission within the remaining symbols of the slot, the transmitting device may use non-causal rate matching and/or resource mapping to determine which bits to transmit and which bits to puncture. Once the transmitting device has reserved the wireless medium (for example, by transmitting the rate-matched PSSCH transmission), the wireless medium may be available to the transmitting device for a channel occupancy time (COT). In the following slot (e.g., the second slot of the COT), the transmitting device may transmit sidelink control information (SCI) that indicates parameters associated with the rate-matched PSSCH transmission, thereby enabling the receiving device to process and decode the rate-matched PSSCH transmission from the preceding slot.

Aspects of the present disclosure may be implemented to realize one or more of the following advantages. The described techniques may improve the likelihood of a first device successfully accessing sidelink resources in a shared RF spectrum band by enabling the first device to begin using the sidelink resources immediately after the first device clears LBT, as opposed to waiting until the next slot to begin transmission(s). Reducing the amount of time between when the first device clears LBT and when the first device begins using the sidelink resources may decrease the probability of other devices occupying the sidelink resources in the interim. Moreover, the non-causal PSSCH rate matching techniques described herein may improve the likelihood of the first device reserving the sidelink resources without increasing the processing/decoding burden on other devices.

Aspects of the disclosure are initially described in the context of wireless communications systems, network architectures, resource diagrams, and process flows. Aspects of the disclosure are further illustrated by and described with reference to apparatus diagrams, system diagrams, and flowcharts that relate to techniques for scheduling non-causal sidelink transmissions.

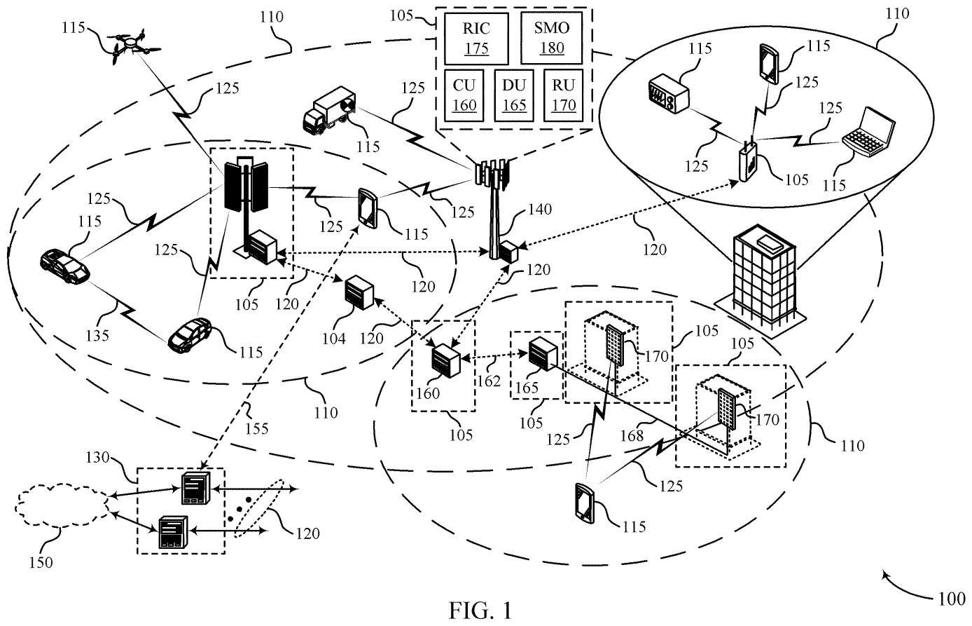

FIG. 1 illustrates an example of a wireless communications system 100 that supports techniques for scheduling non-causal sidelink transmissions in accordance with one or more aspects of the present disclosure. The wireless communications system 100 may include one or more network entities 105, one or more UEs 115, and a core network 130. In some examples, the wireless communications system 100 may be a LTE network, an LTE-Advanced (LTE-A) network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115.

In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof.

An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)).

The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170).

A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor.

An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for scheduling non-causal sidelink transmissions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given RAT (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation.

A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element (RE) may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115.

For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)).

The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some devices operating in a shared or unlicensed RF spectrum band (such as SL-U) may experience resource starvation, where a device is repeatedly blocked from accessing resources in the shared or unlicensed RF spectrum band due to transmissions from other devices. Communications in SL-U may be slot-based and, as such, transmissions may have to start at a slot boundary. Although cyclic prefix (CP) extensions and automatic gain control (AGC) symbol puncturing may permit multiple starting positions around the slot boundary, the starting positions are centered around a few symbols near the slot boundary. Long CP extensions and padding signals can lead to implementation and/or inter-RAT issues. Devices operating in SL-U may experience resource starvation when competing with Wi-Fi devices that use asynchronous channel access schemes. For example, Wi-Fi devices may transmit right after clearing LBT, which may block SL-U transmissions when the Wi-Fi devices clear LBT in SL-U symbols 1-12.

To mitigate resource starvation in SL-U, some wireless communication schemes may support more transmission starting points using a mini-slot resource pool and resource pool switching mechanisms. Using a mini-slot structure may improve the channel access success rate of SL-U devices competing with asynchronous Wi-Fi devices. A mini-slot structure may include at least two half slots, an AGC symbol, physical sidelink control channel (PSCCH) resources, and/or PSSCH resources (for example, a miniature version of a sidelink slot). A sidelink device can rate match PSSCH to close the mini-slot end gap for mini-slot burst. Adding more backoff for AGC in unlicensed frequency bands may help mitigate cross-20MHz sub-band interference from Wi-Fi devices. Mini-slot to full slot sidelink transmissions may also help mitigate this issue. Additionally, or alternatively, sidelink devices may switch to a full-slot resource pool for efficiency. The transmit-receive pair starts off with a mini-slot resource for channel access, and switches to a full slot resource pool based on, for example, a dynamic SCI indication or slot boundary.

Other possible solutions to resource starvation include using overlapping mini-slot resource pools, offset slot resource pools, and/or full slot resource pools to support more starting points after clearing LBT. The transmitting device may select the resource pool with mini-slots or slot(s) with the closest mini-slot or slot boundary.

Depending on device capability, the receiving device can monitor both the mini-slot and full slot resource pool, or just the full slot resource pool. The transmitting device may, in some examples, schedule transmissions to receiving devices with relatively high capabilities in a mini-slot resource pool at the beginning of the data burst to improve channel access success rate. When overlapping mini-slot resource pools are used, the first mini-slot can share SCI decoding with the full slot resource pool when the receiving device is monitoring both resource pools.

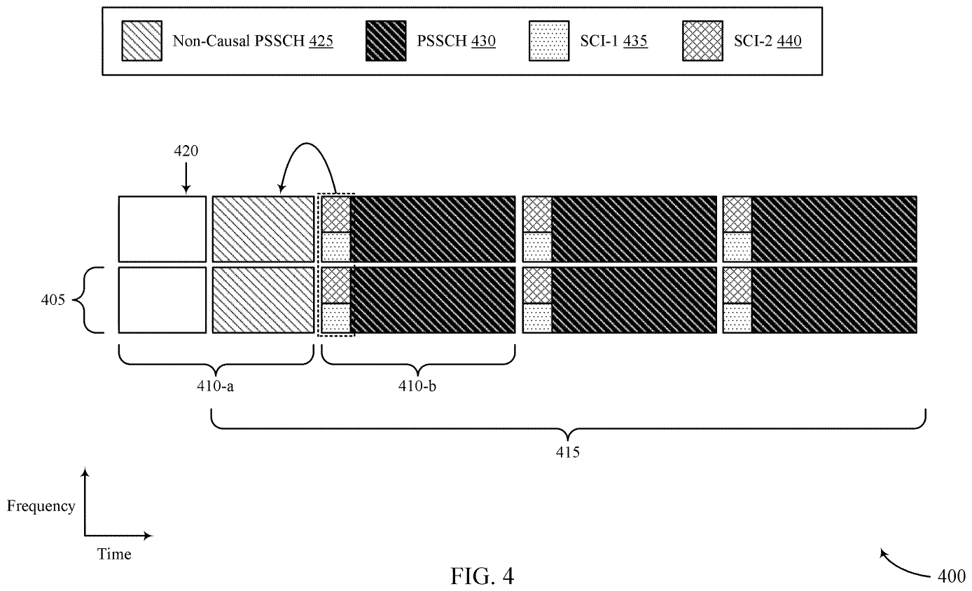

In accordance with aspects of the present disclosure, a UE 115 (for example, a transmitting device) may perform a channel access procedure during a first slot of a COT to reserve sidelink resources in a shared RF spectrum band. If, for example, the UE 115 successfully completes the channel access procedure in the first slot, the UE 115 may transmit a non-causal PSSCH transmission (such as the non-causal PSSCH transmission 425 described with reference to FIG. 4) to a second device (for example, a second UE 115) via one or more of the sidelink resources during a remaining portion of the first slot. In the following slot (e.g., the second slot of the COT), the UE 115 may transmit SCI (for example, SCI-1 or SCI-2) that indicates one or more parameters associated with the non-causal PSSCH transmission in the first slot, thereby enabling the second device to retroactively decode the non-causal PSSCH transmission from the first slot of the COT.

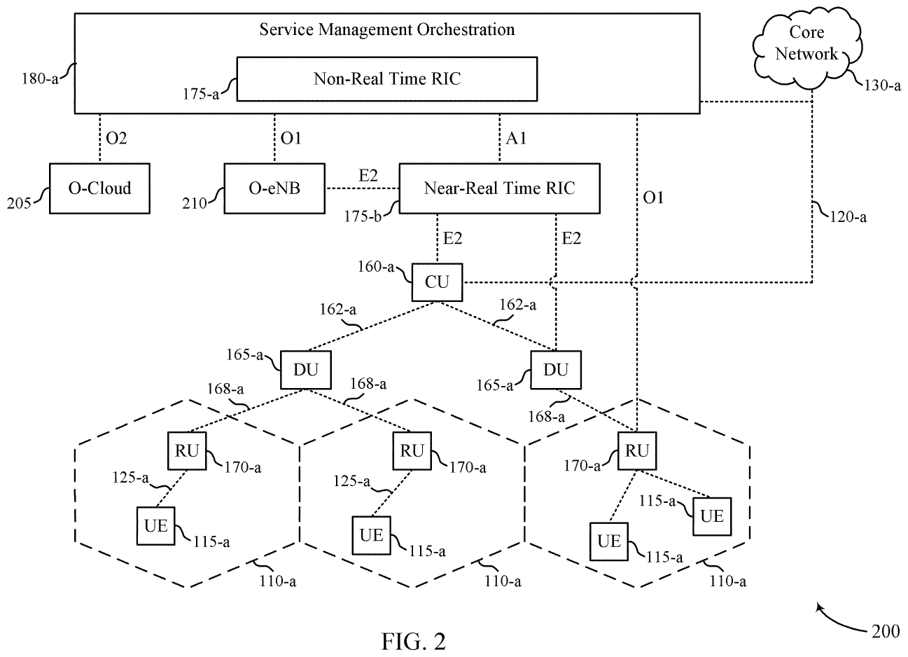

FIG. 2 illustrates an example of a network architecture 200 (e.g., a disaggregated base station architecture, a disaggregated RAN architecture) that supports techniques for scheduling non-causal sidelink transmissions in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an El interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3GPP. In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In accordance with aspects of the present disclosure, the UE 115-a (for example, a transmitting device) may perform a channel access procedure during a first slot of a COT to reserve sidelink resources in a shared RF spectrum band. If, for example, the UE 115-a successfully completes the channel access procedure in the first slot, the UE 115-a may transmit a non-causal PSSCH transmission (such as the non-causal PSSCH transmission 425 described with reference to FIG. 4) to a second device (for example, a receiving device) via one or more of the sidelink resources during a remaining portion of the first slot. In the following slot (e.g., the second slot of the COT), the UE 115-a may transmit SCI (for example, SCI-1 or SCI-2) that indicates one or more parameters associated with the non-causal PSSCH transmission in the first slot, thereby enabling the second device to retroactively decode the non-causal PSSCH transmission from the first slot of the COT.

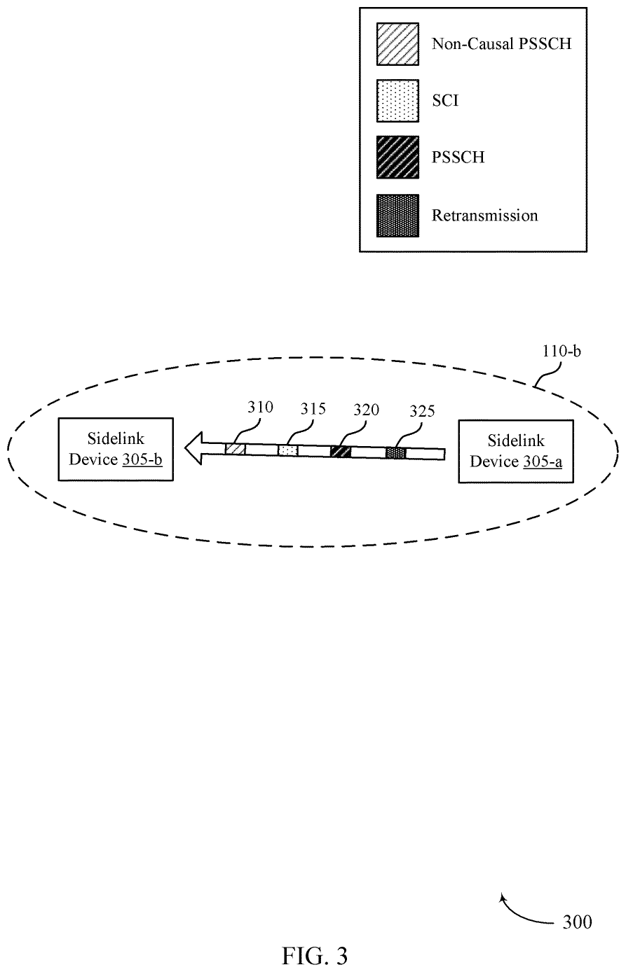

FIG. 3 illustrates an example of a wireless communications system 300 that supports techniques for scheduling non-causal sidelink transmissions in accordance with one or more aspects of the present disclosure. The wireless communications system 300 may implement or be implemented by aspects of the wireless communications system 100 or the network architecture 200. For example, the wireless communications system 300 includes a sidelink device 305-a (e.g., a transmitting device) and a sidelink device 305-b (e.g., a receiving device), each of which may be an example of aspects of a UE 115, as described with reference to FIGS. 1 and 2. The sidelink device 305-a may communicate with the sidelink device 305-b within a coverage area 110-b, which may be an example of a coverage area 110 described with reference to FIG. 1.

As disclosed herein, some devices operating in a shared or unlicensed RF spectrum band (such as SL-U) may experience resource starvation, where a device is repeatedly blocked from accessing resources in the shared or unlicensed RF spectrum band due to transmissions from other devices. Communications in SL-U may be slot-based and, as such, transmissions may start at slot boundaries. Although cyclic prefix (CP) extensions and automatic gain control (AGC) symbol puncturing may permit multiple starting positions around the slot boundary, the starting positions are centered around a few symbols near the slot boundary. Long CP extensions and padding signals can lead to implementation and/or inter-RAT issues. Devices operating in SL-U may experience resource starvation when competing with Wi-Fi devices that use asynchronous channel access schemes. For example, Wi-Fi devices may transmit right after clearing LBT, which may block SL-U transmissions when the Wi-Fi devices clear LBT in SL-U symbols 1-12.

Some approaches to mitigate resource starvation, such as using overlapping mini-slot and slot-based resource pools, may involve configuring two resource pools, and the transmitting device may have to switch between two resource pools (depending on when the LBT is cleared), which could result in prohibitive overhead for the transmitting device. Using a dynamic starting symbol increases the number of decoding hypotheses for PSCCH/PSSCH resources. In contrast, non-causal PSSCH rate matching may enable the transmitting device (such as the sidelink device 305-a) to begin transmitting immediately after clearing LBT, without increasing the number of decoding hypotheses at the receiving device (for example, the sidelink device 305-b).

Aspects of the present disclosure generally provide for scheduling non-causal PSSCH transmissions in a shared or unlicensed RF spectrum band, such as SL-U. In accordance with the techniques described herein, the sidelink device 305-a (for example, a transmitting device) may perform a channel access procedure during a first slot of a COT to reserve sidelink resources in a shared RF spectrum band. If, for example, the sidelink device 305-a successfully completes the channel access procedure in the first slot, the first device may transmit a non-causal PSSCH transmission 310 to the sidelink device 305-b (for example, a receiving device) via one or more of the sidelink resources during a remaining portion of the first slot. In the following slot (e.g., the second slot of the COT), the sidelink device 305-a may transmit SCI 315 (for example, SCI-1 or SCI-2) that indicates one or more parameters associated with the non-causal PSSCH transmission 310 in the first slot, thereby enabling the sidelink device 305-b to retroactively decode the non-causal PSSCH transmission 310 from the first slot of the COT.

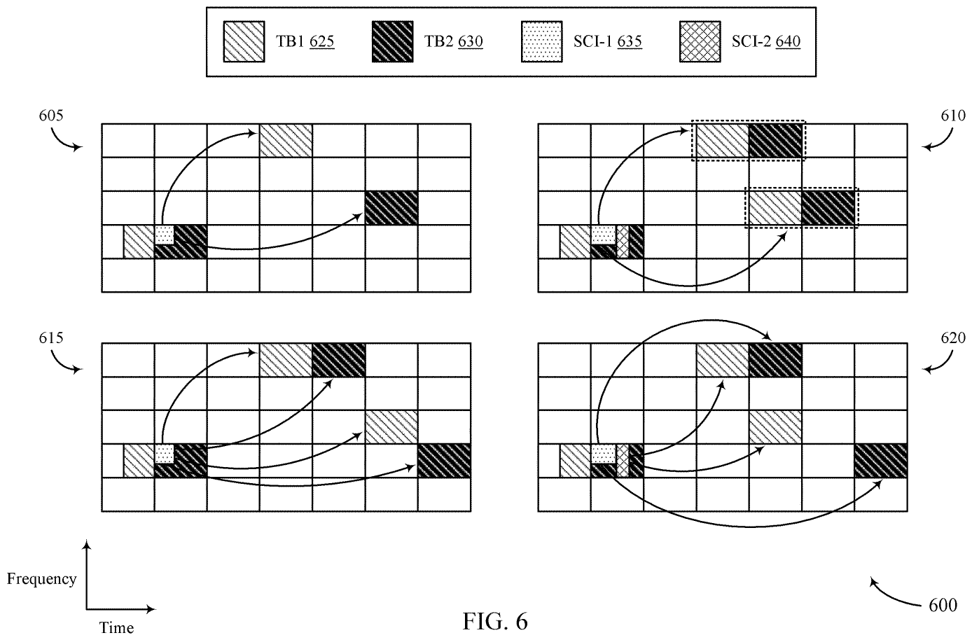

The sidelink device 305-a may also transmit a PSSCH transmission 320 to the sidelink device 305-b during the second slot of the COT via one or more of the sidelink resources in the shared RF spectrum band. In some examples, the first slot of the COT (starting at a non-default symbol) may be associated with the same scheduling parameters (for example, beta offset indicator, frequency allocation, coding rate) as the second slot of the COT. In other examples, the first slot of the COT may be associated with scheduling parameters that are different from the second slot of the COT. In some examples, the SCI 315 may reserve one or more resources for a retransmission 325 of a TB from the non-causal PSSCH transmission 310. Additionally, or alternatively, the SCI 315 may reserve one or more resources for retransmission of a TB from the PSSCH transmission 320, as described with reference to FIG. 6.

Aspects of the wireless communications system 300 may be implemented to realize one or more of the following advantages. The techniques described with reference to FIG. 3 may improve the likelihood of the sidelink device 305-a (for example, a transmitting device) successfully accessing sidelink resources in a shared RF spectrum band (such as SL-U) by enabling the sidelink device 305-a to begin using the sidelink resources immediately after the sidelink device 305-a clears LBT, as opposed to waiting until the next slot to begin transmission(s). Reducing the amount of time between when the sidelink device 305-a clears LBT and when the sidelink device 305-b begins using the sidelink resources may decrease the probability of other devices occupying the sidelink resources in the interim. Moreover, the non-causal PSSCH rate matching techniques described herein may improve the likelihood of the sidelink device 305-a successfully accessing the sidelink resources without increasing the processing/decoding burden on the sidelink device 305-b (for example, a receiving device).

FIG. 4 illustrates an example of a resource diagram 400 that supports techniques for scheduling non-causal sidelink transmissions in accordance with one or more aspects of the present disclosure. The resource diagram 400 may implement or be implemented by aspects of any of the wireless communications systems and network architectures described with reference to FIGS. 1 through 3. For example, the resource diagram 400 may be implemented by the sidelink device 305-a (a UE 115 that supports sidelink communications), as described with reference to FIG. 3. The resource diagram 400 includes a non-causal PSSCH transmission 425, a PSSCH transmission 430, SCI-1 435 (also referred to as first-stage SCI), and SCI-2 440 (also referred to as second-stage SCI), which may be communicated via a sub-channel 405 in an unlicensed RF spectrum band (such as SL-U).

In accordance with examples disclosed herein, a transmitting device (such as the sidelink device 305-a described with reference to FIG. 3) may transmit the non-causal PSSCH transmission 425 to a receiving device (such as the sidelink device 305-b described with reference to FIG. 3) after clearing LBT in a slot 410-a (the first slot of a COT 415). In some implementations, the slot 410-a may have the same scheduling parameters as a slot 410-b (the second slot of the COT 415). In such cases, if non-causal PSSCH rate matching is used, the receiving device may be unable to determine whether a non-causal PSSCH transmission 425 is present in the slot 410-a and/or when the non-causal PSSCH transmission 425 began (e.g., the first symbol of the COT 415). Moreover, the receiving device may be unable to determine whether information from the slot 410-a is carried in the slot 410-b.

If the slot 410-a (starting from a non-default symbol) has the same scheduling parameters as the slot 410-b and the non-causal PSSCH transmission 425 in the slot 410-a carries the same TB as a PSSCH transmission 430 in the slot 410-b, the transmitting device may add a bit to SCI-1 435 or SCI-2 440 in the slot 410-b to indicate whether there is a PSSCH transmission starting from a non-default symbol in the slot 410-a. For example, a value of 1 may indicate there is a PSSCH transmission starting at a non-default symbol in the slot 410-a, whereas a value of 0 may indicate that a non-causal PSSCH transmission is not present in the slot 410-a.

Additionally, or alternatively, the transmitting device may add a field to SCI-1 435 or SCI-2 440 in the slot 410-b to indicate the actual starting symbol of the non-causal PSSCH transmission 425 in the slot 410-a. In some examples, the field may indicate the absolute value of the starting symbol of the non-causal PSSCH transmission 425. Depending on device capability, the transmitting device may only be permitted to transmit non-causal PSSCH transmissions if LBT is cleared at or before a point in time 420 (for example, before the seventh symbol in the slot 410-a). In other examples, the transmitting device may quantize the starting position of the non-causal PSSCH transmission 425. For instance, the starting position of the non-causal PSSCH transmission 425 may be symbol I1, symbol I2, or symbols I3. In such cases, two bits may be added to SCI-1 435 or SCI-2 440 in the slot 410-b to indicate the actual starting symbol of the non-causal PSSCH transmission 425 in the slot 410-a.

Alternatively, if the slot 410-a and the slot 410-b are associated with the same scheduling parameters but the non-causal PSSCH transmission 425 (in the slot 410-a) and the PSSCH transmission 430 (in the slot 410-b) carry different TBs, the transmitting device may add a bit to SCI-1 435 or SCI-2 440 in the slot 410-b to indicate whether the transmitting device used non-causal PSSCH rate matching in the slot 410-a. If the slot 410-a includes a non-causal PSSCH transmission (such as the non-causal PSSCH transmission 425), one or both of the SCI-1 435 or the SCI-2 440 in the slot 410-b may indicate a starting symbol of the non-causal PSSCH transmission. If TBs in the slot 410-a and the slot 410-b of the COT 415 are associated with the same destination identifier, the transmitting device may use SCI-2 440 to indicate a new data indicator (NDI) and redundancy version (RV) for the TB in the slot 410-a (the first slot of the COT 415).

For HARQ process numbers, the transmitting device may define a mapping rule between the slot 410-a and the slot 410-b within the COT 415. The HARQ process identifier for the TB in the slot 410-a (for example, a TB associated with the non-causal PSSCH transmission 425) may be one less than the HARQ process identifier of the TB in the slot 410-b (for example, a TB associated with the PSSCH transmission 430). Alternatively, the transmitting device may explicitly indicate HARQ process identifiers for TBs in the slot 410-a and the slot 410-b. If, for example, TBs in the slot 410-a and the slot 410-b are associated with different destination identifiers, the transmitting device may separately indicate HARQ process identifiers, NDIs, RVs, and destination identifiers for TBs in the slot 410-a and the slot 410-b.

In some examples, the transmitting device may use a specific SCI-2 format to indicate all scheduling information for the slot 410-a and the slot 410-b in the COT 415. If SCI-1 435 points to an instance of SCI-2 440 with this format, the receiving device may determine that non-causal PSSCH rate matching was used in the slot 410-a. The content of this SCI-2 format may be similar to other SCI-2 formats described herein.

In other examples, if scheduling parameters associated with the slot 410-a (starting from a non-default symbol) are different from scheduling parameters associated with the slot 410-b and both slots in the COT 415 carry the same TB, the transmitting device may add a bit field to SCI-1 435 in the slot 410-b of the COT 415 to indicate scheduling parameters for the TB in the slot 410-a of the COT 415. If, for example, the TB in the slot 410-a has the same frequency allocation as the TB in the slot 410-b, the SCI-1 435 may indicate one or more of a demodulation reference signal (DMRS) pattern, a modulation and coding scheme (MCS), or a beta offset indicator for the TB in the slot 410-a. If TBs in the slot 410-a and the slot 410-b of the COT 415 have different frequency allocations, the SCI-1 435 in the slot 410-b of the COT 415 may also indicate the starting frequency and/or the number of sub-channels used to transmit the TB in the slot 410-a of the COT 415.

Additionally, or alternatively, the transmitting device may add a bit field to SCI-2 440 in the slot 410-b of the COT 415 to indicate scheduling parameters for the TB in slot 410-a of the COT 415. If the non-causal PSSCH transmission 425 in the slot 410-a and the PSSCH transmission 430 in the slot 410-b of the COT 415 carry different TBs, one or both of the SCI-1 435 or the SCI-2 440 in the slot 410-b may further indicate a destination identifier, a HARQ process identifier, an NDI, and an RV for the TB in the slot 410-a of the COT 415.

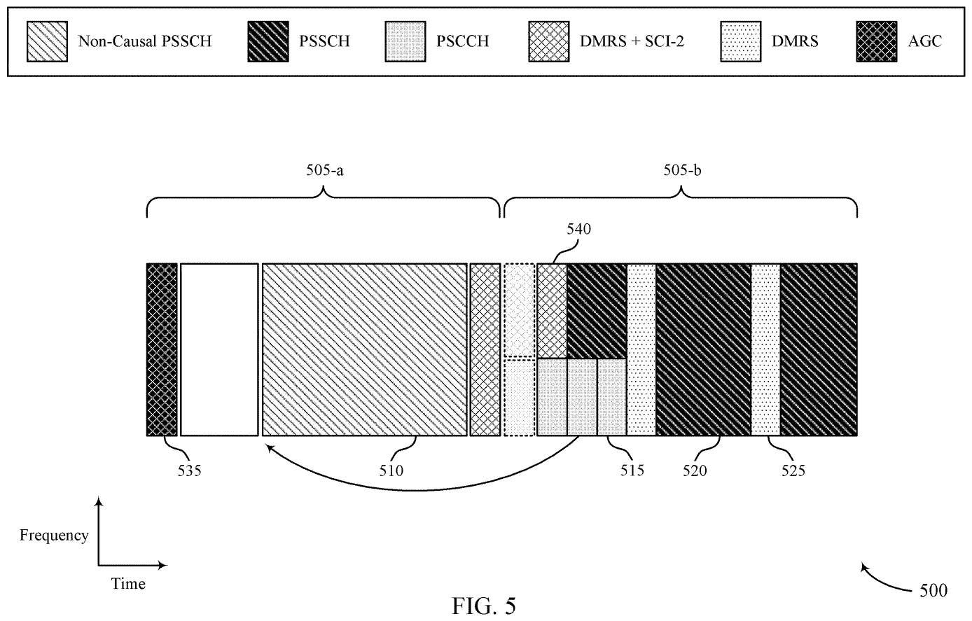

FIG. 5 illustrates an example of a resource diagram 500 that supports techniques for scheduling non-causal sidelink transmissions in accordance with one or more aspects of the present disclosure. The resource diagram 500 may implement or be implemented by aspects of any of the wireless communications systems, network architectures, and resource diagrams described with reference to FIGS. 1 through 4. For example, the resource diagram 500 may be implemented by the sidelink device 305-a (a UE 115 that supports sidelink communications), as described with reference to FIG. 3. The resource diagram 500 includes a non-causal PSSCH transmission 510, a PSSCH transmission 520, a DMRS 525, a PSCCH transmission 515, and an AGC symbol 535.

As disclosed herein, some devices may use dynamic starting symbols to mitigate resource starvation. Communication schemes that leverage dynamic starting symbols may enable a transmitting device (such as the sidelink device 305-a described with reference to FIG. 3) to start PSCCH and PSSCH transmissions at the closest starting symbol after clearing the LBT. The transmitting device may revert or fall back to default symbols in later slots. In such examples, PSCCH and PSSCH resource mapping(s) and DMRS pattern(s) may start from the closest starting symbol.

In contrast, non-causal PSSCH rate matching may enable the transmitting device to rate match a PSSCH transmission 520 from a slot 505-b (the second slot of a COT) if a slot 505-a (the first slot of the COT) starts at a non-default symbol. As an example, the transmitting device may rate match the PSSCH transmission 520 to the slot 505-a from the non-default starting symbol of the slot 505-a and puncture the non-causal PSSCH transmission 510 in the slot 505-a based on the actual starting symbol after clearing the LBT.

In some examples, if the slot 505-a (the first slot of the COT) has the same scheduling parameters as the slot 505-b (the second slot of the COT), the transmitting device may repeat SCI-2 from the slot 505-a during a gap symbol in the slot 505-a to ensure that the receiver can receive the SCI-2 if the non-causal PSSCH transmission 510 is present in the slot 505-a. Thereafter, one bit may be added to SCI in the slot 505-b to indicate whether the slot 505-a includes the non-causal PSSCH transmission 510. To ensure that SCI-2 is equally distributed in the frequency domain, the number of available REs at the gap symbol may be denoted as N_{RE, gap}, and the required number of REs for SCI-2 may be denoted as N_{RE, SCI2}. If N_{RE, gap}<N_{RE, SCI2}, the actual number of REs for SCI-2 may be N_{RE, gap}. Otherwise, if N_{RE, gap}>N_{RE, SCI2}, the combined number of REs for SCI-2 will be [N_{RE, gap}/N_{RE, SCI2}]. The rest of the REs may be used for DMRS transmission.

In the example of FIG. 5, the transmitting device may perform a channel access procedure after an AGC symbol 535 in the slot 505-a. If the transmitting device completes the channel access procedure during the slot 505-a, the transmitting device may transmit the non-causal PSSCH transmission 510 in the remaining portion of the slot 505-a. Thereafter, the transmitting device may transmit a PSCCH transmission 515, a PSSCH transmission 520, and at least one DMRS 525 during the slot 505-b (the second slot of the COT). SCI-1 (which may be included in the PSCCH transmission 515) and/or SCI-2 (which may be transmitted via resources 540 allocated for DMRS and SCI-2) may indicate, for example, the starting symbol of the non-causal PSSCH transmission 510 in the slot 505-a, scheduling parameters for the PSSCH transmission 520, a DMRS pattern associated with the at least one DMRS 525, a set of resources reserved for retransmission of the non-causal PSSCH transmission 510 and/or the PSSCH transmission 520, etc.

Aspects of the resource diagram 500 may be implemented to realize one or more of the following advantages. The techniques described with reference to FIG. 5 may improve the likelihood of a transmitting device successfully accessing sidelink resources in a shared RF spectrum band by enabling the transmitting device to begin using the sidelink resources immediately after the transmitting clears LBT, as opposed to waiting until the next slot to begin transmission(s). Reducing the amount of time between when the transmitting device clears LBT and when the transmitting device begins using the sidelink resources may decrease the probability of other devices occupying the sidelink resources in the interim. Moreover, the non-causal PSSCH rate matching techniques described herein may improve the likelihood of the transmitting device successfully accessing the sidelink resources without increasing the processing/decoding burden on the receiving device.

FIG. 6 illustrates an example of a resource diagram 600 that supports techniques for scheduling non-causal sidelink transmissions in accordance with one or more aspects of the present disclosure. The resource diagram 600 may implement or be implemented by aspects of any of the wireless communications systems, network architectures, and resource diagrams described with reference to FIGS. 1 through 5. For example, the resource diagram 600 may be implemented by the sidelink device 305-a (a UE 115 that supports sidelink communications), as described with reference to FIG. 3. The resource diagram 600 includes a retransmission scheme 605, a retransmission scheme 610, a retransmission scheme 615, and a retransmission scheme 620.

As described herein with reference to FIGS. 1 through 5, a first device (for example, a transmitting device) may perform a channel access procedure (such as an LBT procedure) during a first slot of a COT to reserve sidelink resources in a shared RF spectrum band (e.g., SL-U). If, for example, the first device successfully completes the channel access procedure in the first slot, the first device may transmit a non-causal PSSCH transmission to a second device (for example, a receiving device) via one or more of the sidelink resources during a remaining portion of the first slot. In the following slot (e.g., the second slot of the COT), the first device may transmit SCI (for example, SCI-1 635 or SCI-2 640) that indicates one or more parameters associated with the non-causal PSSCH transmission in the first slot, thereby enabling the second device to retroactively decode the non-causal PSSCH transmission from the first slot.

The first device may also transmit a second PSSCH transmission to the second device during the second slot via one or more of the sidelink resources in the shared RF spectrum band.

In some examples, the SCI in the second slot may reserve one or more resources for retransmission of a TB from the non-causal PSSCH transmission in the first slot of the COT. If, for example, the non-causal PSSCH transmission in the first slot of the COT and the second PSSCH transmission in the second slot of the COT carry the same TB, the first device may use resources reserved in the second slot of the COT for retransmission of the TB from the first slot. Alternatively, if the PSSCH transmissions in the first and second slots of the COT carry different TBs, the first device may use one of the retransmission schemes depicted in the example of FIG. 6 to repurpose or re-interpret resources reserved by the SCI in the second slot.

In the retransmission scheme 605, SCI-1 635 in the second slot of the COT may reserve two resources. The first resource may be used for retransmission of a first TB 625 (TB1) from the first slot of the COT, while the second resource may be used for retransmission of a second TB 630 (TB2) from the second slot of the COT. Thus, in the retransmission scheme 605, SCI-1 635 may reserve two resources: one for retransmission of the first TB 625, the other for retransmission of the second TB 630.

Each reserved resource may include one slot. In the retransmission scheme 610, each resource reserved by SCI-1 635 may include two continuous slots. That is, each resource reserved by SCI-1 635 may include two consecutive slots: the first slot of each reserved resource may be used for retransmission of the first TB 625, while the second slot of each reserved resource may be used for retransmission of the second TB 630 (or vice versa).

In the retransmission scheme 615, at least one bit field may be added to SCI-1 635 in the second slot of the COT to reserve one or more resources for retransmission of the first TB 625 from the first slot of the COT. Thus, SCI-1 635 in the second slot of the COT may reserve one or more resources for retransmission of the first TB 625 and one or more resources for retransmission of the second TB 630. In the retransmission scheme 620, at least one bit field may be added to SCI-2 640 in the second slot of the COT to reserve one or more resources for retransmission of the first TB 625. Thus, SCI-1 635 may reserve one or more resources for retransmission of the second TB 630, while SCI-2 640 may reserve one or more resources for retransmission of the first TB 625.

Aspects of the resource diagram 600 may be implemented to realize one or more of the following advantages. The techniques described with reference to FIG. 6 may improve the likelihood of a first device (for example, a transmitting device) successfully accessing sidelink resources in a shared RF spectrum band by enabling the first device to begin using the sidelink resources immediately after the first device clears LBT, as opposed to waiting until the next slot to begin transmission(s). Reducing the amount of time between when the first device clears LBT and when the first device begins using the sidelink resources may decrease the probability of other devices occupying the sidelink resources in the interim. Moreover, the resource reservation schemes depicted in the example of FIG. 6 may enable the first device to retransmit TB(s) from the first slot (for example, the slot in which the first device cleared LBT) using resources reserved in the following slot.

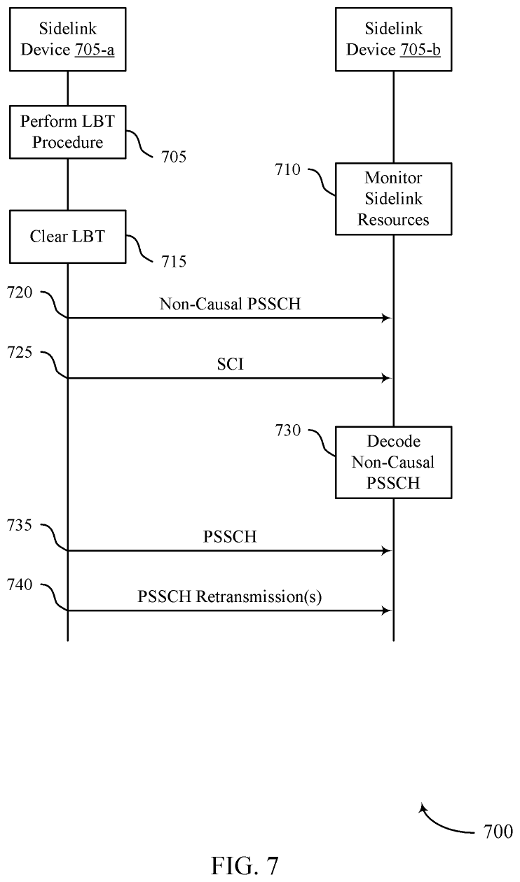

FIG. 7 illustrates an example of a process flow 700 that supports techniques for scheduling non-causal sidelink transmissions in accordance with one or more aspects of the present disclosure. The process flow 700 may implement or be implemented by aspects of any of the wireless communications systems, network architectures, or resource diagrams described with reference to FIGS. 1 through 6. For example, the process flow 700 includes a sidelink device 705-a and a sidelink device 705-b, each of which may be an example of a UE 115 or a network entity 105, as described with reference to FIG. 1. In the following description of the process flow 700, operations between the sidelink device 705-a (a transmitting device) and the sidelink device 705-a (a receiving device) may be added, omitted, or performed in a different order (with respect to the exemplary order shown).

At 705, the sidelink device 705-a may perform an LBT procedure (also referred to herein as a channel access procedure) during a first slot to reserve sidelink resources in a shared RF spectrum band (equivalently referred to as an unlicensed RF spectrum band) for a COT (such as the COT 415 described with reference to FIG. 4). At 710, the sidelink device 705-b may monitor the sidelink resources in the shared RF spectrum band. The sidelink resources may include, for example, a set of PSSCH resources, a set of PSCCH resources, a set of DMRS resources, or any combination thereof. In some examples, the sidelink resources may be a part of a sidelink resource pool.

At 715, the sidelink device 705-a may clear LBT (e.g., complete a successful channel access procedure) at least one symbol after a slot boundary associated with the first slot of the COT (for example, just before the seventh symbol in the first slot).

Rather than waiting until the next slot, the sidelink device 705-a may transmit a non-causal PSSCH transmission (such as the non-causal PSSCH transmission 310 described with reference to FIG. 3) to the sidelink device 705-b at 720 via the sidelink resources in the shared RF spectrum band during a remaining portion of the first slot (for example, after clearing LBT at 715).

At 725, the sidelink device 705-a may transmit SCI (such as the SCI 315 described with reference to FIG. 3) to the sidelink device 705-a via the sidelink resources in the shared RF spectrum band during a second slot (e.g., the slot 505-b described with reference to FIG. 5) that begins after the first slot. As described herein, the SCI may indicate one or more parameters associated with the non-causal PSSCH transmission from the first slot. For example, the SCI may indicate one or more of a DMRS pattern, an MCS, a beta offset indicator, a frequency allocation, a HARQ process identifier, a destination identifier, an NDI, an RV, a starting frequency, or a quantity of sub-channels associated with the non-causal PSSCH transmission.

At 730, the sidelink device 705-b may decode the non-causal PSSCH transmission from the first slot in the COT based on the parameters indicated by the SCI. For example, the sidelink device 705-b may use non-causal PSSCH rate matching information and other details (frequency allocation, MCS, RV, NDI) from the SCI to properly decode the non-causal PSSCH transmission from the sidelink device 705-a.

At 735, the sidelink device 705-a may transmit a PSSCH transmission (such as the PSSCH transmission 320 described with reference to FIG. 3) to the sidelink device 705-b via the sidelink resources in the shared RF spectrum band during the second slot of the COT. In some examples, the PSSCH transmission in the second slot of the COT and the non-causal PSSCH transmission in the first slot of the COT may include the same TB. In other examples, the PSSCH transmission in the second slot of the COT and the non-causal PSSCH transmission in the first slot of the COT may include different TBs.

The non-causal PSSCH transmission in the first slot and the PSSCH transmission in the second slot may have the same scheduling parameters (for example, MCS, bandwidth, starting frequency, number of sub-carriers) or different scheduling parameters. The contents of the SCI (transmitted at 725) may depend on whether the non-causal PSSCH transmission in the first slot of the COT and the PSSCH transmission in the second slot of the COT have the same scheduling parameters and/or whether the non-causal PSSCH transmission in the first slot of the COT and the PSSCH transmission in the second slot of the COT include the same TB.

At 740, the sidelink device 705-a may retransmit TB(s) from one or both of the non-causal PSSCH transmission (in the first slot of the COT) or the PSSCH transmission (in the second slot of the COT) using resources reserved by the SCI. If, for example, the non-causal PSSCH transmission and the PSSCH transmission carry different TBs, the sidelink device 705-a may reserve a first set of resources for retransmission of a TB from the non-causal PSSCH transmission and a second set of resources for retransmission of a TB from the PSSCH transmission. The first set of resources and the second set of resources may be contiguous or discontinuous in time and/or frequency, as illustrated in the example of FIG. 6.

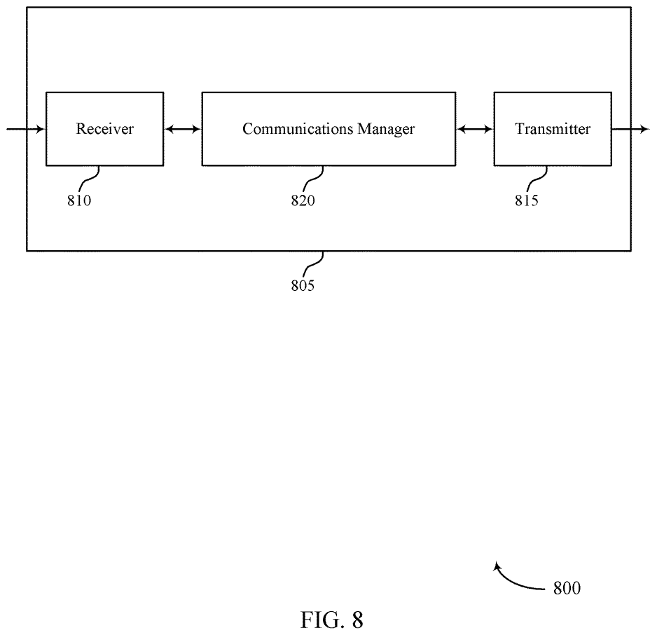

FIG. 8 illustrates a block diagram 800 of a device 805 that supports techniques for scheduling non-causal sidelink transmissions in accordance with one or more aspects of the present disclosure. The device 805 may be an example of aspects of a UE 115, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for scheduling non-causal sidelink transmissions).

Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for scheduling non-causal sidelink transmissions). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for scheduling non-causal sidelink transmissions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first device (for example, the device 805) in accordance with examples disclosed herein. For example, the communications manager 820 may be configured as or otherwise support a means for performing a channel access procedure during a first slot to reserve sidelink resources in a shared RF spectrum band for a COT. The communications manager 820 may be configured as or otherwise support a means for transmitting a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The communications manager 820 may be configured as or otherwise support a means for transmitting SCI via the sidelink resources in the shared RF spectrum band during a second slot that begins after the first slot, where the SCI indicates one or more parameters associated with the non-causal sidelink transmission in the first slot.

Additionally, or alternatively, the communications manager 820 may support wireless communication at a second device (for example, the device 805) in accordance with examples disclosed herein. For example, the communications manager 820 may be configured as or otherwise support a means for monitoring sidelink resources in a shared RF spectrum band. The communications manager 820 may be configured as or otherwise support a means for receiving, from a first device that has reserved the sidelink resources in the shared RF spectrum band for a COT, SCI that indicates one or more parameters associated with a non-causal sidelink transmission in a first slot, where the SCI is received during a second slot that begins after the first slot. The communications manager 820 may be configured as or otherwise support a means for decoding the non-causal sidelink transmission from the first slot based on the one or more parameters indicated by the SCI, where the non-causal sidelink transmission begins at least one symbol after a slot boundary associated with the first slot.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced power consumption and more efficient utilization of communication resources by reducing the number of unsuccessful channel access procedures performed by the device 805.

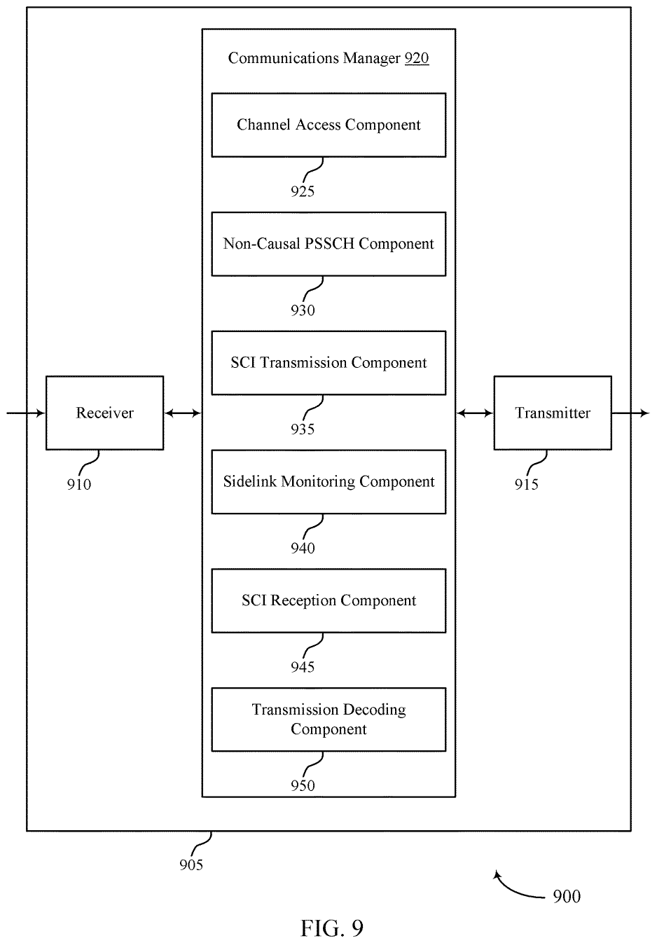

FIG. 9 illustrates a block diagram 900 of a device 905 that supports techniques for scheduling non-causal sidelink transmissions in accordance with one or more aspects of the present disclosure. The device 905 may be an example of aspects of a device 805 or a UE 115, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for scheduling non-causal sidelink transmissions).

Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for scheduling non-causal sidelink transmissions). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for scheduling non-causal sidelink transmissions as described herein. For example, the communications manager 920 may include a channel access component 925, a non-causal PSSCH component 930, an SCI transmission component 935, a sidelink monitoring component 940, an SCI reception component 945, a transmission decoding component 950, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first device (for example, the device 905) in accordance with examples disclosed herein. The channel access component 925 may be configured as or otherwise support a means for performing a channel access procedure during a first slot to reserve sidelink resources in a shared RF spectrum band for a COT. The non-causal PSSCH component 930 may be configured as or otherwise support a means for transmitting a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The SCI transmission component 935 may be configured as or otherwise support a means for transmitting SCI via the sidelink resources in the shared RF spectrum band during a second slot that begins after the first slot, where the SCI indicates one or more parameters associated with the non-causal sidelink transmission in the first slot.

Additionally, or alternatively, the communications manager 920 may support wireless communication at a second device (such as the device 905) in accordance with examples disclosed herein. The sidelink monitoring component 940 may be configured as or otherwise support a means for monitoring sidelink resources in a shared RF spectrum band. The SCI reception component 945 may be configured as or otherwise support a means for receiving, from a first device that has reserved the sidelink resources in the shared RF spectrum band for a COT, SCI that indicates one or more parameters associated with a non-causal sidelink transmission in a first slot, where the SCI is received during a second slot that begins after the first slot. The transmission decoding component 950 may be configured as or otherwise support a means for decoding the non-causal sidelink transmission from the first slot based on the one or more parameters indicated by the SCI, where the non-causal sidelink transmission begins at least one symbol after a slot boundary associated with the first slot.

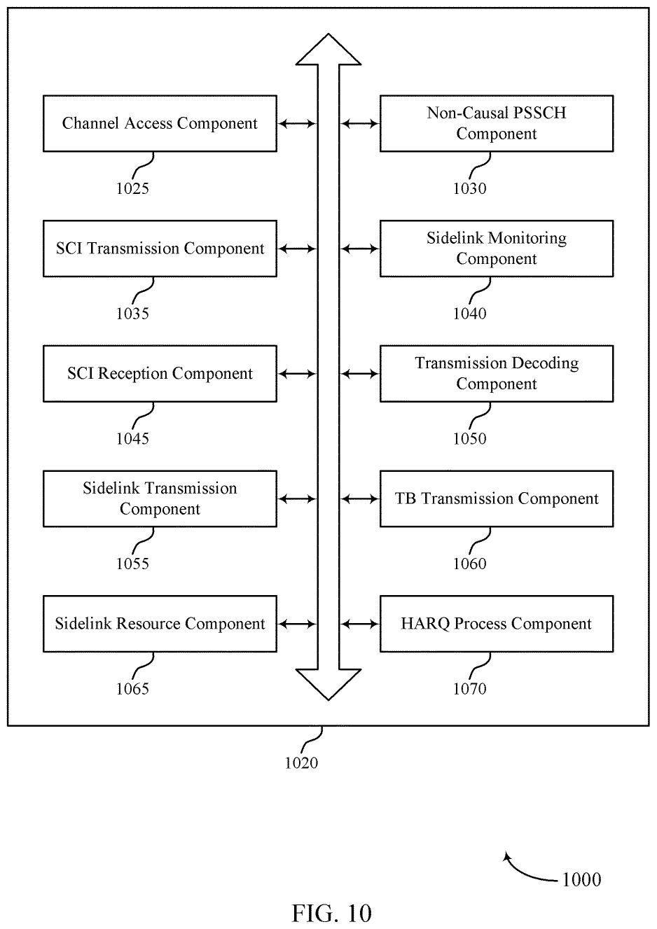

FIG. 10 illustrates a block diagram 1000 of a communications manager 1020 that supports techniques for scheduling non-causal sidelink transmissions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for scheduling non-causal sidelink transmissions as described herein. For example, the communications manager 1020 may include a channel access component 1025, a non-causal PSSCH component 1030, an SCI transmission component 1035, a sidelink monitoring component 1040, an SCI reception component 1045, a transmission decoding component 1050, a sidelink transmission component 1055, a TB transmission component 1060, a sidelink resource component 1065, an HARQ process component 1070, or any combination thereof. Each of these components may communicate, directly or indirectly, with one another (e.g., via one or more buses).

The communications manager 1020 may support wireless communication at a first device (such as the device 905 described with reference to FIG. 9) in accordance with examples disclosed herein. The channel access component 1025 may be configured as or otherwise support a means for performing a channel access procedure during a first slot to reserve sidelink resources in a shared RF spectrum band for a COT. The non-causal PSSCH component 1030 may be configured as or otherwise support a means for transmitting a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The SCI transmission component 1035 may be configured as or otherwise support a means for transmitting SCI via the sidelink resources in the shared RF spectrum band during a second slot that begins after the first slot, where the SCI indicates one or more parameters associated with the non-causal sidelink transmission in the first slot.

In some examples, the sidelink transmission component 1055 may be configured as or otherwise support a means for transmitting at least one sidelink transmission during the second slot using the one or more parameters associated with the non-causal sidelink transmission in the first slot, the non-causal sidelink transmission including a first instance of a TB, the at least one sidelink transmission including a second instance of the TB.

In some examples, to support transmitting the SCI during the second slot, the SCI transmission component 1035 may be configured as or otherwise support a means for transmitting first-stage SCI or second-stage SCI that indicates whether a sidelink transmission starting at a non-default symbol is present in the first slot.

In some examples, to support transmitting the SCI during the second slot, the SCI transmission component 1035 may be configured as or otherwise support a means for transmitting first-stage SCI or second-stage SCI that indicates an absolute value of a first symbol of the non-causal sidelink transmission in the first slot.

In some examples, to support transmitting the non-causal sidelink transmission, the non-causal PSSCH component 1030 may be configured as or otherwise support a means for transmitting the non-causal sidelink transmission during the remaining portion of the first slot based on completing the channel access procedure prior to a seventh symbol in the first slot in accordance with a capability of the first device to perform non-causal sidelink transmissions.

In some examples, to support transmitting the SCI during the second slot, the SCI transmission component 1035 may be configured as or otherwise support a means for transmitting first-stage SCI or second-stage SCI that indicates a quantized position of a first symbol of the non-causal sidelink transmission in the first slot.

In some examples, the sidelink transmission component 1055 may be configured as or otherwise support a means for transmitting at least one sidelink transmission during the second slot using the one or more parameters associated with the non-causal sidelink transmission in the first slot, the non-causal sidelink transmission including a first TB, the at least one sidelink transmission including a second TB that is different from the first TB.

In some examples, to support transmitting the SCI during the second slot, the SCI transmission component 1035 may be configured as or otherwise support a means for transmitting first-stage SCI or second-stage SCI that indicates whether non-causal rate matching is used for sidelink transmissions in the first slot. In some examples, the first TB and the second TB may be associated with a same destination identifier.

In some examples, to support transmitting the SCI during the second slot, the SCI transmission component 1035 may be configured as or otherwise support a means for transmitting second-stage SCI that indicates one or more of an NDI, an RV, or a HARQ process identifier for the first TB.

In some examples, the HARQ process component 1070 may be configured as or otherwise support a means for determining a first HARQ process identifier for the first TB based on a mapping between the first slot and the second slot, where a value of the first HARQ process identifier is one less than a value of a second HARQ process identifier for the second TB.

In some examples, the first HARQ process identifier and the second HARQ process identifier are indicated separately. In some examples, the first TB and the second TB are associated with different destination identifiers.

In some examples, to support transmitting the SCI during the second slot, the SCI transmission component 1035 may be configured as or otherwise support a means for transmitting first SCI that indicates one or more of a HARQ process identifier, an NDI, an RV, or a destination identifier for the first TB. In some examples, to support transmitting the SCI during the second slot, the SCI transmission component 1035 may be configured as or otherwise support a means for transmitting second SCI that indicates one or more of a HARQ process identifier, an NDI, an RV, or a destination identifier for the second TB, where the first SCI and the second SCI are indicated separately.

In some examples, the SCI includes second-stage SCI. In some examples, a format of the second-stage SCI indicates that non-causal rate matching is used for sidelink transmissions in the first slot.

In some examples, to support transmitting the SCI, the SCI transmission component 1035 may be configured as or otherwise support a means for transmitting second-stage SCI during the first slot. In some examples, to support transmitting the SCI, the SCI transmission component 1035 may be configured as or otherwise support a means for retransmitting the second-stage SCI during a gap symbol between the first slot and the second slot using some or all REs available during the gap symbol.

In some examples, the sidelink transmission component 1055 may be configured as or otherwise support a means for transmitting at least one sidelink transmission during the second slot via the sidelink resources using parameters that are different from the one or more parameters associated with the non-causal sidelink transmission in the first slot, the non-causal sidelink transmission including a first instance of a TB, the at least one sidelink transmission including a second instance of the TB.

In some examples, the first instance of the TB and the second instance of the TB are associated with a same frequency allocation. In some examples, the SCI indicates a DMRS pattern, an MCS, and a beta offset identifier for the first instance of the TB.

In some examples, the first instance of the TB and the second instance of the TB are associated with different frequency allocations. In some examples, the SCI indicates a DMRS pattern, an MCS, a beta offset indicator, a quantity of sub-channels, and a starting frequency for the first instance of the TB.

In some examples, the sidelink transmission component 1055 may be configured as or otherwise support a means for transmitting at least one sidelink transmission during the second slot using parameters that are different from the one or more parameters associated with the non-causal sidelink transmission in the first slot, the non-causal sidelink transmission including a first TB, the at least one sidelink transmission including a second TB that is different from the first TB.

In some examples, to support transmitting the SCI during the second slot, the SCI transmission component 1035 may be configured as or otherwise support a means for transmitting first-stage SCI or second-stage SCI that indicates a destination identifier, a HARQ process identifier, an RV, and an NDI for the first TB.

In some examples, the sidelink transmission component 1055 may be configured as or otherwise support a means for transmitting at least one sidelink transmission during the second slot using the sidelink resources in the shared RF spectrum band, the non-causal sidelink transmission in the first slot including a first instance of a TB, the at least one sidelink transmission in the second slot including a second instance of the TB. In some examples, the TB transmission component 1060 may be configured as or otherwise support a means for retransmitting the TB using a set of sidelink resources reserved by the SCI.

In some examples, the sidelink transmission component 1055 may be configured as or otherwise support a means for transmitting at least one sidelink transmission during the second slot using the sidelink resources in the shared RF spectrum band, the non-causal sidelink transmission in the first slot including a first TB, the at least one sidelink transmission in the second slot including a second TB that is different from the first TB. In some examples, the TB transmission component 1060 may be configured as or otherwise support a means for retransmitting the first TB using a first set of sidelink resources reserved by the SCI. In some examples, the TB transmission component 1060 may be configured as or otherwise support a means for retransmitting the second TB using a second set of sidelink resources reserved by the SCI, where the first set of sidelink resources and the second set of sidelink resources each include one slot.

In some examples, the sidelink transmission component 1055 may be configured as or otherwise support a means for transmitting at least one sidelink transmission during the second slot using the sidelink resources in the shared RF spectrum band, the non-causal sidelink transmission in the first slot including a first TB, the at least one sidelink transmission in the second slot including a second TB that is different from the first TB. In some examples, the TB transmission component 1060 may be configured as or otherwise support a means for retransmitting the first TB using a first set of sidelink resources reserved by the SCI. In some examples, the TB transmission component 1060 may be configured as or otherwise support a means for retransmitting the second TB using a second set of sidelink resources reserved by the SCI, where the first set of sidelink resources and the second set of sidelink resources each include two consecutive slots.

In some examples, to support transmitting the SCI during the second slot, the SCI transmission component 1035 may be configured as or otherwise support a means for transmitting first-stage SCI or second-stage SCI that indicates the first set of sidelink resources reserved for retransmission of the first TB.

In some examples, the sidelink resources in the shared RF spectrum band include sidelink shared channel resources, sidelink control channel resources, DMRS resources, or a combination thereof. In some examples, the COT includes at least the remaining portion of the first slot and the second slot that begins after the first slot.

In some examples, the one or more parameters indicated by the SCI include one or more of a DMRS pattern, an MCS, a beta offset indicator, a frequency allocation, a HARQ process identifier, a destination identifier, an NDI, an RV, a starting frequency, or a quantity of sub-channels associated with the non-causal sidelink transmission in the first slot.

Additionally, or alternatively, the communications manager 1020 may support wireless communication at a second device in accordance with examples disclosed herein. The sidelink monitoring component 1040 may be configured as or otherwise support a means for monitoring sidelink resources in a shared RF spectrum band. The SCI reception component 1045 may be configured as or otherwise support a means for receiving, from a first device that has reserved the sidelink resources in the shared RF spectrum band for a COT, SCI that indicates one or more parameters associated with a non-causal sidelink transmission in a first slot, where the SCI is received during a second slot that begins after the first slot. The transmission decoding component 1050 may be configured as or otherwise support a means for decoding the non-causal sidelink transmission from the first slot based on the one or more parameters indicated by the SCI, where the non-causal sidelink transmission begins at least one symbol after a slot boundary associated with the first slot.

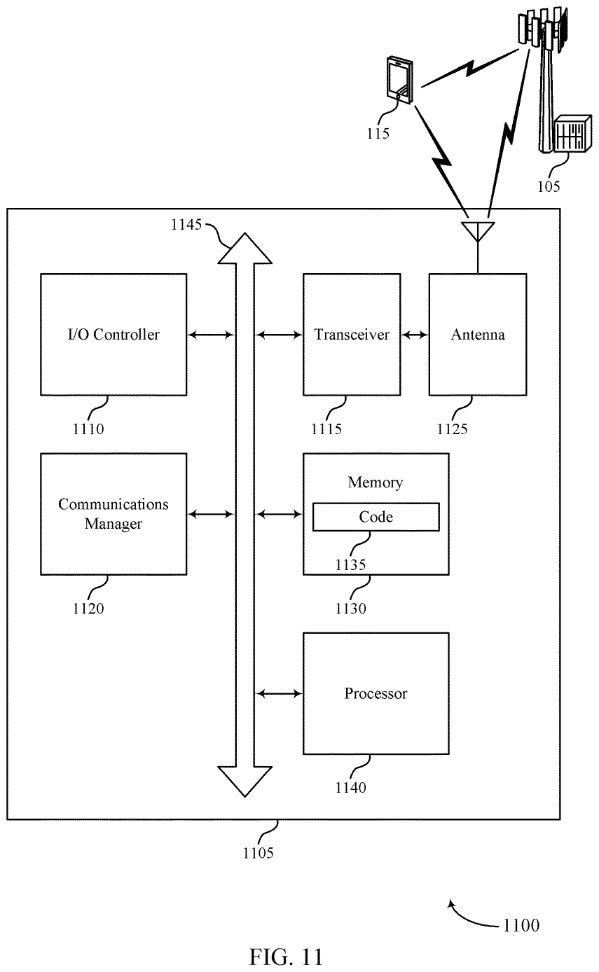

FIG. 11 illustrates a diagram of a system 1100 including a device 1105 that supports techniques for scheduling non-causal sidelink transmissions in accordance with one or more aspects of the present disclosure. The device 1105 may be an example of or include the components of a device 805, a device 905, or a device as described herein. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140.

These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions.

The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for scheduling non-causal sidelink transmissions). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a first device (such as the device 1105) in accordance with examples disclosed herein. For example, the communications manager 1120 may be configured as or otherwise support a means for performing a channel access procedure during a first slot to reserve sidelink resources in a shared RF spectrum band for a COT. The communications manager 1120 may be configured as or otherwise support a means for transmitting a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The communications manager 1120 may be configured as or otherwise support a means for transmitting SCI via the sidelink resources in the shared RF spectrum band during a second slot that begins after the first slot, where the SCI indicates one or more parameters associated with the non-causal sidelink transmission in the first slot.

Additionally, or alternatively, the communications manager 1120 may support wireless communication at a second device (such as the device 1105) in accordance with examples disclosed herein. For example, the communications manager 1120 may be configured as or otherwise support a means for monitoring sidelink resources in a shared RF spectrum band. The communications manager 1120 may be configured as or otherwise support a means for receiving, from a first device that has reserved the sidelink resources in the shared RF spectrum band for a COT, SCI that indicates one or more parameters associated with a non-causal sidelink transmission in a first slot, where the SCI is received during a second slot that begins after the first slot.

The communications manager 1120 may be configured as or otherwise support a means for decoding the non-causal sidelink transmission from the first slot based on the one or more parameters indicated by the SCI, where the non-causal sidelink transmission begins at least one symbol after a slot boundary associated with the first slot.

By including or configuring the communications manager 1120 in accordance with examples as described herein, the device 1105 may support techniques for increasing the likelihood of successfully accessing sidelink resources in a shared RF spectrum band, for example, by enabling the device 1105 to begin using the sidelink resources immediately after the transmitting clears LBT, instead of waiting until the next slot. Reducing the amount of time between when the device 1105 clears LBT and when the device 1105 begins using the sidelink resources may decrease the probability of other devices occupying the sidelink resources in the interim. Moreover, the non-causal PSSCH rate matching techniques described herein may improve the likelihood of the device 1105 successfully accessing the sidelink resources without increasing the processing/decoding burden on the receiving device(s).

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for scheduling non-causal sidelink transmissions as described herein, or the processor 1140 and the memory 1130 may be otherwise configured to perform or support such operations.

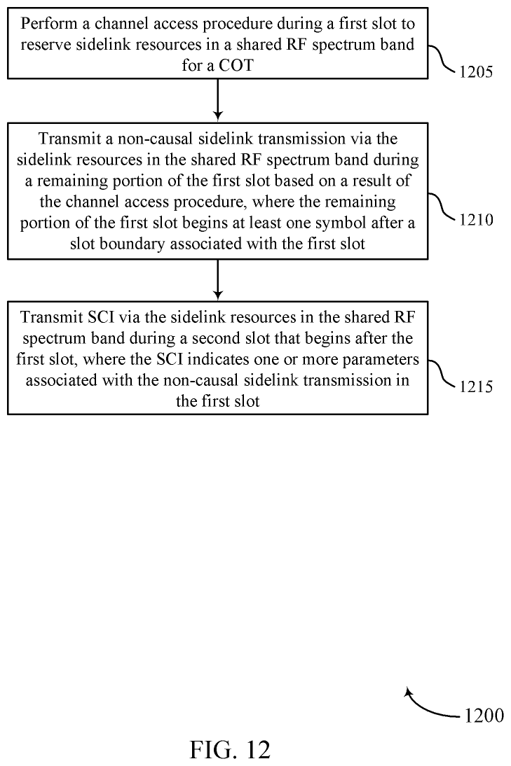

FIG. 12 illustrates a flowchart illustrating a method 1200 that supports techniques for scheduling non-causal sidelink transmissions in accordance with one or more aspects of the present disclosure. The operations of the method 1200 may be implemented by a device or components thereof. For example, the operations of the method 1200 may be performed by a UE 115, as described with reference to FIGS. 1 through 11. In some examples, a device may execute a set of instructions to control functional elements of the device to perform the described functions. Additionally, or alternatively, the device may perform aspects of the described functions using special-purpose hardware.

At 1205, a first device (such as the sidelink device 305-a described with reference to FIG. 3) may perform a channel access procedure during a first slot to reserve sidelink resources in a shared RF spectrum band for a COT. The operations of 1205 may be performed in accordance with examples disclosed herein. In some examples, aspects of the operations of 1205 may be performed by a channel access component 1025, as described with reference to FIG. 10.

At 1210, the first device may transmit a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The operations of 1210 may be performed in accordance with examples disclosed herein. In some examples, aspects of the operations of 1210 may be performed by a non-causal PSSCH component 1030, as described with reference to FIG. 10.

At 1215, the first device may transmit SCI via the sidelink resources in the shared RF spectrum band during a second slot that begins after the first slot, where the SCI indicates one or more parameters associated with the non-causal sidelink transmission in the first slot. The operations of 1215 may be performed in accordance with examples disclosed herein. In some examples, aspects of the operations of 1215 may be performed by an SCI transmission component 1035, as described with reference to FIG. 10.

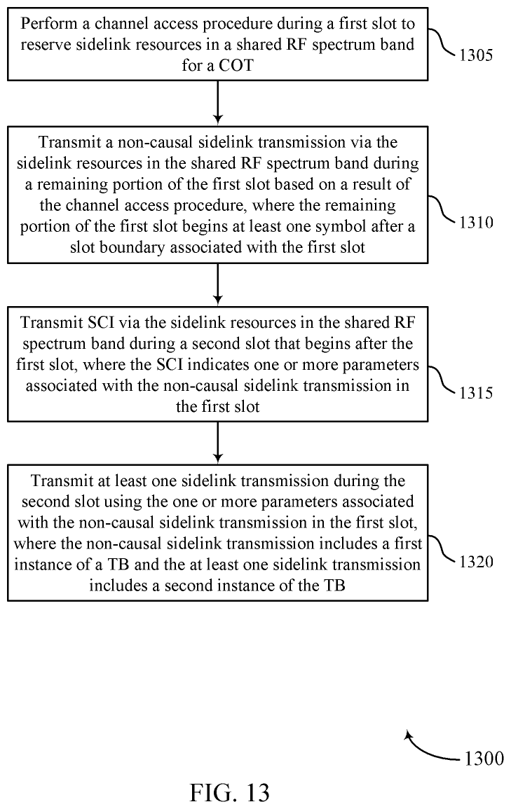

FIG. 13 illustrates a flowchart illustrating a method 1300 that supports techniques for scheduling non-causal sidelink transmissions in accordance with one or more aspects of the present disclosure. The operations of the method 1300 may be implemented by a device or components thereof. For example, the operations of the method 1300 may be performed by a UE 115, as described with reference to FIGS. 1 through 11. In some examples, a device may execute a set of instructions to control the functional elements of the device to perform the described functions. Additionally, or alternatively, the device may perform aspects of the described functions using special-purpose hardware.

At 1305, a first device (such as the sidelink device 305-a described with reference to FIG. 3) may perform a channel access procedure during a first slot to reserve sidelink resources in a shared RF spectrum band for a COT. The operations of 1305 may be performed in accordance with examples disclosed herein. In some examples, aspects of the operations of 1305 may be performed by a channel access component 1025, as described with reference to FIG. 10.

At 1310, the first device may transmit a non-causal sidelink transmission via the sidelink resources in the shared RF spectrum band during a remaining portion of the first slot based on a result of the channel access procedure, where the remaining portion of the first slot begins at least one symbol after a slot boundary associated with the first slot. The operations of 1310 may be performed in accordance with examples disclosed herein. In some examples, aspects of the operations of 1310 may be performed by a non-causal PSSCH component 1030, as described with reference to FIG. 10.

At 1315, the first device may transmit SCI via the sidelink resources in the shared RF spectrum band during a second slot that begins after the first slot, where the SCI indicates one or more parameters associated with the non-causal sidelink transmission in the first slot. The operations of 1315 may be performed in accordance with examples disclosed herein. In some examples, aspects of the operations of 1315 may be performed by an SCI transmission component 1035, as described with reference to FIG. 10.

At 1320, the first device may transmit at least one sidelink transmission during the second slot using the one or more parameters associated with the non-causal sidelink transmission in the first slot, the non-causal sidelink transmission including a first instance of a TB, the at least one sidelink transmission including a second instance of the TB. The operations of 1320 may be performed in accordance with examples disclosed herein. In some examples, aspects of the operations of 1320 may be performed by a sidelink transmission component 1055, as described with reference to FIG. 10.

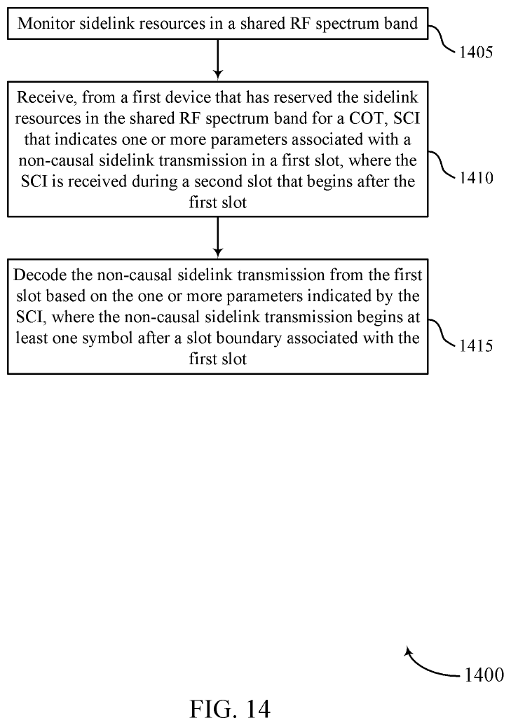

FIG. 14 illustrates a flowchart illustrating a method 1400 that supports techniques for scheduling non-causal sidelink transmissions in accordance with one or more aspects of the present disclosure. The operations of the method 1400 may be implemented by a device or components thereof. For example, the operations of the method 1400 may be performed by a UE 115, as described with reference to FIGS. 1 through 11. In some examples, a device may execute a set of instructions to control the functional elements of the device to perform the described functions. Additionally, or alternatively, the device may perform aspects of the described functions using special-purpose hardware.

At 1405, a second device (such as the sidelink device 305-b described with reference to FIG. 3) may monitor sidelink resources in a shared RF spectrum band. The operations of 1405 may be performed in accordance with examples disclosed herein. In some examples, aspects of the operations of 1405 may be performed by a sidelink monitoring component 1040, as described with reference to FIG. 10.

At 1410, the second device may receive, from a first device that has reserved the sidelink resources in the shared RF spectrum band for a COT, SCI that indicates one or more parameters associated with a non-causal sidelink transmission in a first slot, where the SCI is received during a second slot that begins after the first slot. The operations of 1410 may be performed in accordance with examples disclosed herein. In some examples, aspects of the operations of 1410 may be performed by an SCI reception component 1045, as described with reference to FIG. 10.

At 1415, the second device may decode the non-causal sidelink transmission from the first slot based on the one or more parameters indicated by the SCI, where the non-causal sidelink transmission begins at least one symbol after a slot boundary associated with the first slot. The operations of 1415 may be performed in accordance with examples disclosed herein. In some examples, aspects of the operations of 1415 may be performed by a transmission decoding component 1050, as described with reference to FIG. 10.

The following provides an overview of aspects of the present disclosure:

Aspect 1: A method for wireless communication at a first device, comprising: performing a channel access procedure during a first slot to reserve sidelink resources in a shared radio frequency spectrum band for a channel occupancy time; transmitting a non-causal sidelink transmission via the sidelink resources in the shared radio frequency spectrum band during a remaining portion of the first slot based at least in part on a result of the channel access procedure, wherein the remaining portion of the first slot begins at least one symbol after a slot boundary associated with the first slot; and transmitting sidelink control information via the sidelink resources in the shared radio frequency spectrum band during a second slot that begins after the first slot, wherein the sidelink control information indicates one or more parameters associated with the non-causal sidelink transmission in the first slot.

Aspect 2: The method of aspect 1, further comprising: transmitting at least one sidelink transmission during the second slot using the one or more parameters associated with the non-causal sidelink transmission in the first slot, the non-causal sidelink transmission comprising a first instance of a transport block, the at least one sidelink transmission comprising a second instance of the transport block.

Aspect 3: The method of any of aspects 1 through 2, wherein transmitting the sidelink control information during the second slot comprises: transmitting first-stage sidelink control information or second-stage sidelink control information that indicates whether a sidelink transmission starting at a non-default symbol is present in the first slot.

Aspect 4: The method of any of aspects 1 through 3, wherein transmitting the sidelink control information during the second slot comprises: transmitting first-stage sidelink control information or second-stage sidelink control information that indicates an absolute value of a first symbol of the non-causal sidelink transmission in the first slot.

Aspect 5: The method of any of aspects 1 through 4, wherein transmitting the non-causal sidelink transmission comprises: transmitting the non-causal sidelink transmission during the remaining portion of the first slot based at least in part on completing the channel access procedure prior to a seventh symbol in the first slot in accordance with a capability of the first device to perform non-causal sidelink transmissions.

Aspect 6: The method of any of aspects 1 through 5, wherein transmitting the sidelink control information during the second slot comprises: transmitting first-stage sidelink control information or second-stage sidelink control information that indicates a quantized position of a first symbol of the non-causal sidelink transmission in the first slot.

Aspect 7: The method of aspect 1, further comprising: transmitting at least one sidelink transmission during the second slot using the one or more parameters associated with the non-causal sidelink transmission in the first slot, the non-causal sidelink transmission comprising a first transport block, the at least one sidelink transmission comprising a second transport block that is different from the first transport block.

Aspect 8: The method of aspect 7, wherein transmitting the sidelink control information during the second slot comprises: transmitting first-stage sidelink control information or second-stage sidelink control information that indicates whether non-causal rate matching is used for sidelink transmissions in the first slot.

Aspect 9: The method of any of aspects 7 through 8, wherein the first transport block and the second transport block are associated with a same destination identifier.

Aspect 10: The method of any of aspects 7 through 9, wherein transmitting the sidelink control information during the second slot comprises: transmitting second-stage sidelink control information that indicates one or more of a new data indicator, a redundancy version, or a hybrid automatic repeat request process identifier for the first transport block.

Aspect 11: The method of any of aspects 7 through 10, further comprising: determining a first hybrid automatic repeat request process identifier for the first transport block based at least in part on a mapping between the first slot and the second slot, wherein a value of the first hybrid automatic repeat request process identifier is one less than a value of a second hybrid automatic repeat request process identifier for the second transport block.

Aspect 12: The method of aspect 11, wherein the first hybrid automatic repeat request process identifier and the second hybrid automatic repeat request process identifier are indicated separately.

Aspect 13: The method of aspect 7, wherein the first transport block and the second transport block are associated with different destination identifiers.

Aspect 14: The method of any of aspects 7 through 13, wherein transmitting the sidelink control information during the second slot comprises: transmitting first sidelink control information that indicates one or more of a hybrid automatic repeat request process identifier, a new data indicator, a redundancy version, or a destination identifier for the first transport block; and transmitting second sidelink control information that indicates one or more of a hybrid automatic repeat request process identifier, a new data indicator, a redundancy version, or a destination identifier for the second transport block, wherein the first sidelink control information and the second sidelink control information are indicated separately.

Aspect 15: The method of any of aspects 1 through 14, wherein the sidelink control information comprises second-stage sidelink control information; and a format of the second-stage sidelink control information indicates that non-causal rate matching is used for sidelink transmissions in the first slot.

Aspect 16: The method of any of aspects 1 through 15, wherein transmitting the sidelink control information comprises: transmitting second-stage sidelink control information during the first slot; and retransmitting the second-stage sidelink control information during a gap symbol between the first slot and the second slot using some or all resource elements available during the gap symbol.

Aspect 17: The method of aspect 1, further comprising: transmitting at least one sidelink transmission during the second slot via the sidelink resources using parameters that are different from the one or more parameters associated with the non-causal sidelink transmission in the first slot, the non-causal sidelink transmission comprising a first instance of a transport block, the at least one sidelink transmission comprising a second instance of the transport block.

Aspect 18: The method of aspect 17, wherein the first instance of the transport block and the second instance of the transport block are associated with a same frequency allocation; and the sidelink control information indicates a demodulation reference signal pattern, a modulation and coding scheme, and a beta offset identifier for the first instance of the transport block.

Aspect 19: The method of aspect 17, wherein the first instance of the transport block and the second instance of the transport block are associated with different frequency allocations; and the sidelink control information indicates a demodulation reference signal pattern, a modulation and coding scheme, a beta offset indicator, a quantity of sub-channels, and a starting frequency for the first instance of the transport block.

Aspect 20: The method of aspect 1, further comprising: transmitting at least one sidelink transmission during the second slot using parameters that are different from the one or more parameters associated with the non-causal sidelink transmission in the first slot, the non-causal sidelink transmission comprising a first transport block, the at least one sidelink transmission comprising a second transport block that is different from the first transport block.

Aspect 21: The method of aspect 20, wherein transmitting the sidelink control information during the second slot comprises: transmitting first-stage sidelink control information or second-stage sidelink control information that indicates a destination identifier, a hybrid automatic repeat request process identifier, a redundancy version, and a new data identifier for the first transport block.

Aspect 22: The method of aspect 1, further comprising: transmitting at least one sidelink transmission during the second slot using the sidelink resources in the shared radio frequency spectrum band, the non-causal sidelink transmission in the first slot comprising a first instance of a transport block, the at least one sidelink transmission in the second slot comprising a second instance of the transport block; and retransmitting the transport block using a set of sidelink resources reserved by the sidelink control information.

Aspect 23: The method of aspect 1, further comprising: transmitting at least one sidelink transmission during the second slot using the sidelink resources in the shared radio frequency spectrum band, the non-causal sidelink transmission in the first slot comprising a first transport block, the at least one sidelink transmission in the second slot comprising a second transport block that is different from the first transport block; retransmitting the first transport block using a first set of sidelink resources reserved by the sidelink control information; and retransmitting the second transport block using a second set of sidelink resources reserved by the sidelink control information, wherein the first set of sidelink resources and the second set of sidelink resources each comprise one slot.

Aspect 24: The method of aspect 1, further comprising: transmitting at least one sidelink transmission during the second slot using the sidelink resources in the shared radio frequency spectrum band, the non-causal sidelink transmission in the first slot comprising a first transport block, the at least one sidelink transmission in the second slot comprising a second transport block that is different from the first transport block; retransmitting the first transport block using a first set of sidelink resources reserved by the sidelink control information; and retransmitting the second transport block using a second set of sidelink resources reserved by the sidelink control information, wherein the first set of sidelink resources and the second set of sidelink resources each comprise two consecutive slots.

Aspect 25: The method of aspect 24, wherein transmitting the sidelink control information during the second slot comprises: transmitting first-stage sidelink control information or second-stage sidelink control information that indicates the first set of sidelink resources reserved for retransmission of the first transport block.

Aspect 26: The method of any of aspects 1 through 25, wherein the sidelink resources in the shared radio frequency spectrum band comprise sidelink shared channel resources, sidelink control channel resources, demodulation reference signal resources, or a combination thereof; and the channel occupancy time comprises at least the remaining portion of the first slot and the second slot that begins after the first slot.

Aspect 27: The method of any of aspects 1 through 26, wherein the one or more parameters indicated by the sidelink control information comprise one or more of a demodulation reference signal pattern, a modulation and coding scheme, a beta offset indicator, a frequency allocation, a hybrid automatic repeat request process identifier, a destination identifier, a new data indicator, a redundancy version, a starting frequency, or a quantity of sub-channels associated with the non-causal sidelink transmission in the first slot.

Aspect 28: A method for wireless communication at a second device, comprising: monitoring sidelink resources in a shared radio frequency spectrum band; receiving, from a first device that has reserved the sidelink resources in the shared radio frequency spectrum band for a channel occupancy time, sidelink control information that indicates one or more parameters associated with a non-causal sidelink transmission in a first slot, wherein the sidelink control information is received during a second slot that begins after the first slot; and decoding the non-causal sidelink transmission from the first slot based at least in part on the one or more parameters indicated by the sidelink control information, wherein the non-causal sidelink transmission begins at least one symbol after a slot boundary associated with the first slot.

Aspect 29: An apparatus for wireless communication at a first device, comprising: a processor; memory coupled with the processor; and instructions stored in the memory and executable by the processor to cause the apparatus to perform a method of any of aspects 1 through 27.

Aspect 30: An apparatus for wireless communication at a first device, comprising at least one means for performing a method of any of aspects 1 through 27.

Aspect 31: A non-transitory computer-readable medium storing code for wireless communication at a first device, the code comprising instructions executable by a processor to perform a method of any of aspects 1 through 27.

Aspect 32: An apparatus for wireless communication at a second device, comprising: a processor; memory coupled with the processor; and instructions stored in the memory and executable by the processor to cause the apparatus to perform the method of aspect 28.

Aspect 33: An apparatus for wireless communication at a second device, comprising at least one means for performing the method of aspect 28.

Aspect 34: A non-transitory computer-readable medium storing code for wireless communication at a second device, the code comprising instructions executable by a processor to perform the method of aspect 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a first device, comprising:
a processor;
memory coupled with the processor; and
instructions stored in the memory and executable by the processor to cause the apparatus to:
perform a channel access procedure during a first slot to reserve sidelink resources in a shared radio frequency spectrum band for a channel occupancy time;
transmit a non-causal sidelink transmission via the sidelink resources in the shared radio frequency spectrum band during a remaining portion of the first slot based at least in part on a result of the channel access procedure, wherein the remaining portion of the first slot begins at least one symbol after a slot boundary associated with the first slot; and
transmit sidelink control information via the sidelink resources in the shared radio frequency spectrum band during a second slot that begins after the first slot, wherein the sidelink control information indicates one or more parameters associated with the non-causal sidelink transmission in the first slot.

2. The apparatus of claim 1, wherein the instructions are further executable by the processor to cause the apparatus to:
transmit at least one sidelink transmission during the second slot using the one or more parameters associated with the non-causal sidelink transmission in the first slot, the non-causal sidelink transmission comprising a first instance of a transport block, the at least one sidelink transmission comprising a second instance of the transport block.

3. The apparatus of claim 1, wherein, to transmit the sidelink control information during the second slot, the instructions are executable by the processor to cause the apparatus to:
transmit first-stage sidelink control information or second-stage sidelink control information that indicates whether a sidelink transmission starting at a non-default symbol is present in the first slot.

4. The apparatus of claim 1, wherein, to transmit the sidelink control information during the second slot, the instructions are executable by the processor to cause the apparatus to:
transmit first-stage sidelink control information or second-stage sidelink control information that indicates an absolute value of a first symbol of the non-causal sidelink transmission in the first slot.

5. The apparatus of claim 1, wherein, to transmit the non-causal sidelink transmission, the instructions are executable by the processor to cause the apparatus to:
transmit the non-causal sidelink transmission during the remaining portion of the first slot based at least in part on completing the channel access procedure prior to a seventh symbol in the first slot in accordance with a capability of the first device to perform non-causal sidelink transmissions.

6. The apparatus of claim 1, wherein, to transmit the sidelink control information during the second slot, the instructions are executable by the processor to cause the apparatus to:
transmit first-stage sidelink control information or second-stage sidelink control information that indicates a quantized position of a first symbol of the non-causal sidelink transmission in the first slot.

7. The apparatus of claim 1, wherein the instructions are further executable by the processor to cause the apparatus to:
transmit at least one sidelink transmission during the second slot using the one or more parameters associated with the non-causal sidelink transmission in the first slot, the non-causal sidelink transmission comprising a first transport block, the at least one sidelink transmission comprising a second transport block that is different from the first transport block.

8. The apparatus of claim 7, wherein, to transmit the sidelink control information during the second slot, the instructions are executable by the processor to cause the apparatus to:
transmit first-stage sidelink control information or second-stage sidelink control information that indicates whether non-causal rate matching is used for sidelink transmissions in the first slot.

9. The apparatus of claim 7, wherein the first transport block and the second transport block are associated with a same destination identifier.

10. The apparatus of claim 7, wherein, to transmit the sidelink control information during the second slot, the instructions are executable by the processor to cause the apparatus to:
transmit second-stage sidelink control information that indicates one or more of a new data indicator, a redundancy version, or a hybrid automatic repeat request process identifier for the first transport block.

11. The apparatus of claim 7, wherein the instructions are further executable by the processor to cause the apparatus to:
determine a first hybrid automatic repeat request process identifier for the first transport block based at least in part on a mapping between the first slot and the second slot, wherein a value of the first hybrid automatic repeat request process identifier is one less than a value of a second hybrid automatic repeat request process identifier for the second transport block.

12. The apparatus of claim 11, wherein the first hybrid automatic repeat request process identifier and the second hybrid automatic repeat request process identifier are indicated separately.

13. The apparatus of claim 7, wherein:
the first transport block and the second transport block are associated with different destination identifiers.

14. The apparatus of claim 7, wherein, to transmit the sidelink control information during the second slot, the instructions are executable by the processor to cause the apparatus to:
transmit first sidelink control information that indicates one or more of a hybrid automatic repeat request process identifier, a new data indicator, a redundancy version, or a destination identifier for the first transport block; and
transmit second sidelink control information that indicates one or more of a hybrid automatic repeat request process identifier, a new data indicator, a redundancy version, or a destination identifier for the second transport block, wherein the first sidelink control information and the second sidelink control information are indicated separately.

15. The apparatus of claim 1, wherein:
the sidelink control information comprises second-stage sidelink control information; and
a format of the second-stage sidelink control information indicates that non-causal rate matching is used for sidelink transmissions in the first slot.

16. The apparatus of claim 1, wherein, to transmit the sidelink control information, the instructions are executable by the processor to cause the apparatus to:
transmit second-stage sidelink control information during the first slot; and
retransmit the second-stage sidelink control information during a gap symbol between the first slot and the second slot using some or all resource elements available during the gap symbol.

17. The apparatus of claim 1, wherein the instructions are further executable by the processor to cause the apparatus to:
transmit at least one sidelink transmission during the second slot via the sidelink resources using parameters that are different from the one or more parameters associated with the non-causal sidelink transmission in the first slot, the non-causal sidelink transmission comprising a first instance of a transport block, the at least one sidelink transmission comprising a second instance of the transport block.

18. The apparatus of claim 17, wherein:
the first instance of the transport block and the second instance of the transport block are associated with a same frequency allocation; and
the sidelink control information indicates a demodulation reference signal pattern, a modulation and coding scheme, and a beta offset identifier for the first instance of the transport block.

19. The apparatus of claim 17, wherein:
the first instance of the transport block and the second instance of the transport block are associated with different frequency allocations; and
the sidelink control information indicates a demodulation reference signal pattern, a modulation and coding scheme, a beta offset indicator, a quantity of sub-channels, and a starting frequency for the first instance of the transport block.

20-27. (canceled)

28. An apparatus for wireless communication at a second device, comprising:
a processor;
memory coupled with the processor; and
instructions stored in the memory and executable by the processor to cause the apparatus to:
monitor sidelink resources in a shared radio frequency spectrum band;
receive, from a first device that has reserved the sidelink resources in the shared radio frequency spectrum band for a channel occupancy time, sidelink control information that indicates one or more parameters associated with a non-causal sidelink transmission in a first slot, wherein the sidelink control information is received during a second slot that begins after the first slot; and
decode the non-causal sidelink transmission from the first slot based at least in part on the one or more parameters indicated by the sidelink control information, wherein the non-causal sidelink transmission begins at least one symbol after a slot boundary associated with the first slot.

29-30. (canceled)
